(19) United States
(12) Patent Application Publication
(10) Pub. No.: US 2012/0074717 A1
(43) Pub. Date: Mar. 29, 2012

(54) Sanitary, minimum contact handle

(76) Inventor: Scott Macfarlane, (US)

(21) Appl. No.: 12/892,925

(22) Filed: Sep. 29, 2010

(51) Int. Cl. E05B 3/00; B23P 11/00

(52) U.S. Cl. 292/336.3; 29/428

(57) ABSTRACT

A door opener with a miniature handle sized for operating solely with a pinky minimizes the transfer of germs by reducing the area of the hand in contact with the door opener and limiting contact to a part of the hand less likely to transfer germs to the nose, eyes and mouth. A method for making current door openers more sanitary involves adding a handle sized for operating solely with a pinky. A stackable hand protector shaped like a pilgrim's or witch's hat with a broad rim prevents all contact with the miniature handle.

### BACKGROUND

Using a manual door opener (e.g., handle, knob) with a bare hand can create health issues for the user. Hands often have germs on them, and those germs are easily transferred when a door opener is operated.

Germs transferred by contact with a door opener do not generally infect the person exposed to them through the skin of the hand. Rather, the germs infect the person through his or her nose, eyes or mouth when the hand to which the germs have been transferred from the door opener comes into contact with one of the three. In general, the parts of the hand most likely to come into contact with the eyes, nose or mouth are the index finger and thumb and the parts of the hand closest to the index finger and thumb. Parts of the hand in regular contact with the eyes, nose and mouth, include index finger, especially the tip, knuckle and side adjacent to the thumb, the tip and back of the thumb, and the tip and knuckle of the middle finger. In addition, the tips of the fingers, especially those of the thumb and the first three fingers, frequently come into contact with each other and with the palm of the hand, thereby creating opportunities for a germ picked up by one part of the hand to be transferred to another part of the hand and then to the nose, eyes or mouth.

When operating current manual door openers, including those designed to be operated by wrapping the fingers and sometimes the palm around the opener, such as door knobs, levers and pulls, and those designed to be operated using the finger tips, such as the finger pulls on sliding doors and windows, the parts of the hand most likely to transfer germs from the door opener to the eyes, nose or mouth (i.e., the finger tips, the index and ring fingers, the thumb and the area between the thumb and index finger) are in direct contact with the door opener. Moreover, since finger pulls are designed to be inset into a surface of a door or window parallel to direction of the force that will be applied to the door or window, they are only useful for sliding windows and doors where the force is applied parallel to the exposed surface. Finger pulls cannot generally be used on a hinged door or casement window because the finger pull would have to be inset into an edge of the door or window covered by the frame in which the door and window are hung. Also, because applying a large force using only finger tips is uncomfortable or difficult for most people, finger pulls are generally used only on light windows and sliding doors; for heavy sliding doors, handles are used.

A number of solutions have been developed and proposed to make door openers such as pulls, lever handles and knobs, more sanitary to operate. These solutions include door openers that are not operated using the hand, such as foot-operated pulls, forearm-operated pulls and automatic powered doors, disposable barriers such as paper or plastic sheets to prevent contact between skin of the hand and door opener, and antimicrobial devices, such as copper or silver coatings, alcohol sprayers and UV lighting, which kill germs that may adhere to the opener. None of these solutions has been widely implemented, in part because door openers are very efficient to use and these solutions tend to make them less efficient, in part because some of the solutions are too expensive, and in part because some of the solutions are not completely effective (for example, copper or silver coatings don't kill all germs within a short enough time).

It would be useful to have a way of modifying door openers that could be widely implemented at low cost, and which could be implemented for a wide variety of door openers and other hand-operated devices.

### SUMMARY

One way to minimize the transfer of germs from a door handle to one's nose, eyes and mouth is to minimize the area of the hand that comes into contact with the door handle, and to make sure that the area of contact is localized to a part of the hand that does not often come into contact with the nose, eyes and mouth. It can be observed that one part of the hand comes into contact with the eyes, nose and mouth much less frequently than other parts of the hand; the little finger or pinky (scientific names: digitus minimus manus, digitus quintus, and digitus V). The pinky also tends not to come into contact with other parts of the hand, especially the thumb and parts of the palm touched by other fingers.

The present invention exploits this observation by enabling a person to comfortably pull open a door (or in some embodiments, push closed a door), including releasing a latch in some cases, using only his or her pinky or little finger, thereby both minimizing the area of the hand in contact with a potentially germ-carrying door opener and limiting contact to the part of the hand least likely to transfer those germs to the eyes, nose or mouth. This is accomplished in some embodiments by incorporating into an existing door opening device a novel grip which is sized and shaped so that it can comfortably and safely be operated with just a pinky. This novel grip, which will be referred to herein as a digitus quintus grip (DQ grip), projects outwards from a support, such as a door handle, pull or knob, far enough for one finger (preferably the pinky) to be able to grasp or obtain a purchase on it but not so long that it can be grasped using two fingers (except perhaps by someone with small hands), is small enough around that it can be comfortably grasped with a pinky, and is so positioned on the support that when grasped with a pinky it can be used to comfortably apply a pulling or pushing force to the support. A handle is that part of a thing which is made to be grasped by the hand in using or moving it, and a DQ grip is a handle made to be grasped with the pinky alone, although one will often be able to grasp it using another finger.

A DQ grip can be incorporated into most types of manual door openers, such as door knobs, levers handles, push bars, pull bars, pulls, pull plates, and handle sets. A DQ grip can be incorporated into most of the handles used on hinged and sliding doors, and on most types of doors, including cabinet doors, interior and exterior home doors, rolling doors, refrigerator, freezer and cooler doors, and car doors. The handles that are attached to and used to pull on, rotate or slide other objects can also have DQ grips incorporated into them, such as latch bolts, faucet handles, and window and drawer handles.

One aspect of the present invention is a door opener which incorporates a first handle of sufficient length or girth that substantial portion of at least two fingers to be in contact with it (two or more sections of the fingers); and a second handle that only one finger at a time can be substantially in contact with (two or more sections of the one finger). The second handle measures between about ⅜ and ¾ inch long, and has a maximum cross-sectional dimension or width of between about ¼ and ¾ inch midpoint along its length. The second handle's longitudinal axis is at an angle of between about 45 degrees below horizontal to 90 degrees above horizontal in a plane roughly perpendicular to the direction of movement of the door when opening or closing. In various embodiments, the first handle comprises a pull, a knob, a lever, a push bar, a push-pull paddle, and a pull plate. In one embodiment where the first handle is a pull, the longitudinal axes of the first and second handles are not aligned, and in one embodiment, the longitudinal axes are not parallel.

One aspect of the present invention is a novel door handle which has a first handle attached to a support adapted for mounting to a door which measures between about ¼ and ¾ inches long and width of no more than ¾ inch measured ¼ or more inches away from the support. The longitudinal axis of the first grip is roughly orthogonal to the direction of movement of the door. In one embodiment, the support is a prior art door opener which can incorporate a second grip which is big enough for a substantial part of at least two fingers to be in contact with.

One aspect of the present invention is a method of making a prior art door opener more sanitary having the steps of: providing a manual door opener having a first handle large enough to be grasped by wrapping two or more fingers around it; attaching a first end of a second handle to the door opener such that a longitudinal axis of the second handle will be at an angle of between forty-five degrees below horizontal to ninety degrees above horizontal in a plane roughly perpendicular to the direction of the force to open the door and a second end of the second handle is a distance of between about 0.25 and 0.75 inch from the door opener; wherein the maximum cross-sectional dimension of the second handle measured about 0.25 inch from the door opener is between about 0.25 and 0.75 inch. In one embodiment, the second handle is clamped onto the manual door opener which in one embodiment is a pull. In one embodiment, one end of the second handle conforms to the portion of the manual door opener to which it is attached.

One aspect of the present invention is a stackable protector for preventing skin contact between a small handle which is small enough that only one finger can be in substantial contact with the handle when using it. In one embodiment, the protector is shaped like a miniature witch's hat. In one embodiment, the protector is shaped like a miniature pilgrim's hat. A dispenser similar to paper cup dispensers can be used to hold multiple protectors and dispense them one at a time. One type of protector comprises a handle with a cavity in one end large enough to fit over a one-finger handle and a flange to keep the hand away from the door opener.

### DRAWINGS

FIG. 1A-1D are perspective views of various embodiment of a door pull incorporating a DQ grip.

FIG. 2 is a perspective view of a pull plate door opener incorporating a DQ grip.

FIG. 3 is a perspective view of a slide bolt latch incorporating a DQ grip.

FIG. 4 is a perspective view of a DQ grip being grasped by a hand.

FIGS. 5A, 5B and 5C are perspective views of a protector for preventing all skin contact with a DQ grip and its support.

FIG. 5D is a perspective view of a dispenser for the protector.

FIG. 6 is a perspective view of a DQ grip operator that can clip to a belt or dangle from a wrist.

FIG. 7 is a perspective view of a handle set incorporating a DQ grip on the thumb tab.

FIG. 8 is a perspective view of a lever for a door lock set incorporating a DQ grip at its free end.

FIG. 9 is a perspective view of a lever for a door lock set incorporating a DQ grip in the base of the lever.

FIG. 10 is a perspective view of a door knob incorporating a DQ grip.

FIG. 11A is a perspective view of a door handle for a sliding door which incorporates two DQ grips.

FIG. 11B is a perspective view of a door handle for a sliding door which incorporates two DQ grips.

FIG. 12A is a perspective view of a push bar assembly incorporating a DQ grip.

FIG. 12B is a perspective view of a push-pull paddle handle incorporating a DQ grip.

FIG. 12C is a perspective view of a pull plate incorporating a DQ grip.

FIG. 13A is an exploded perspective view of a DQ grip door opener.

FIG. 13B is an exploded perspective detail of a portion of the DQ grip door opener.

FIG. 13C is a perspective view of a DQ grip door opener mounted on a door.

FIG. 14A-14C are perspective views of various DQ grip assemblies that can be attached to existing handles.

FIG. 14D is a perspective view of a DQ grip for converting certain prior art pulls to pulls incorporating a DQ grip.

FIG. 15 is a perspective view of a lever incorporating a DQ grip at its free end.

FIG. 16 is a plan view of a DQ grip.

### DETAILED DESCRIPTION OF EXEMPLARY EMBODIMENTS OF THE INVENTION

The present invention comprises new manual door openers incorporating a novel grip or handle which is sized, shaped and oriented so that a person can grasp the new grip using only his or her pinky or little finger (scientific names: digitus minimus manus, digitus quintus, and digitus V), and use it to pull or push open the door to which the door opener is attached. These new door openers offer a more sanitary way of manually opening doors which limit contact between a person's hand and the door opener to the pinky and a small portion of the area of the palm adjacent to the pinky. The new one-finger grip or digitus quintus grip (DQ grip) can be incorporated into almost any device that is used to move an object by applying a pulling force (or in some embodiments, a pushing force or a lateral force), such as doors and drawers, including door pulls, door levers and knobs, and drawer pulls. A DQ grip can be added to the activation plates for the powered doors often used to make entrances handicapped-accessible, but the DQ grip will generally be incorporated into manual door openers which are those operated using a hand or some other part of the body to provide both the motive force to open the door and any force, and motion, necessary to operate the door opener to release a latch, if there is one.

A DQ grip projects out from a support intended to be attached to a door (or other movable object). A DQ grip is designed to grasped solely with the pinky, and is oriented so that a force applied appropriately to it will open the door to which the support is attached. The DQ grip will typically be grasped so that either the pinky's metacarpophalangeal joint (the joint between the proximal phalange and the metacarpal) where the base of the pinky meets the palm, the proximal phalange, the proximal interphalangeal joint, the joint between the pinky's intermediate and proximal phalanges, or the intermediate phalange will be in line with the force that will be applied to open the door. The length of the DQ grip (the distance it extends out from the support) is enough for one, and only one finger to wrap around laterally, and it is positioned on and extends from the support such that it can be grasped comfortably using the pinky.

A DQ grip can be incorporated into most existing door opening devices, and thus the support can be a door opener such as one of those currently in use, including but not limited to, a push-pull paddle, sliding door handle, push bar, pull, knob or lever door opener. The support can also be a bracket whose function is to support the DQ grip and connect it to the door.

In the following paragraphs a number of the design considerations for DQ grips, including height, girth, shape, position, composition and orientation, are discussed.

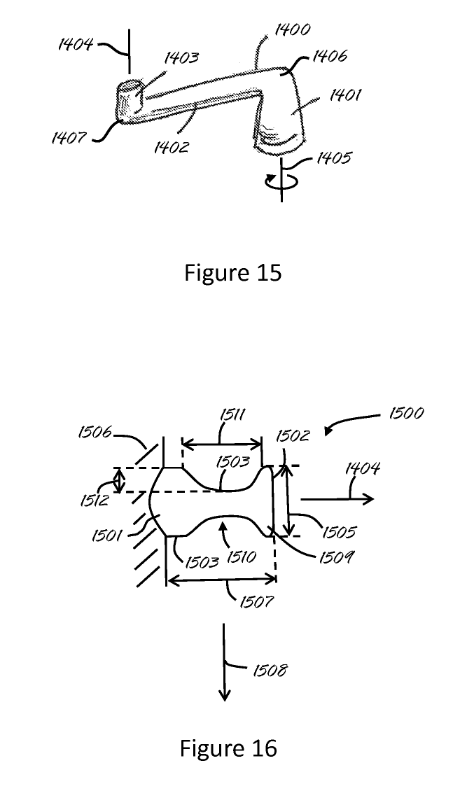

First, it is necessary to explain what certain terms refer to. Referring to FIG. 16, a DQ grip has a bottom or attached end 1501, a top or free end 1502, and lateral sides 1503. The bottom 1501 of a DQ grip is attached to a support 1506. The bottom 1501 will generally conform to the support 1506 (for example, it will be planar if the support is planar at the point of attachment; it will have a concavity if the support is convex—in FIG. 15, the substrate is cylindrical so the DQ grip has a non-planar bottom). The DQ grip 1500 projects outwards from where its bottom 1501 is attached to the support 1506 to a free end 1509. The top 1502 is at the free end 1509. The top 1502 can be as large, or larger, in cross section than the bottom, or it can be smaller, even a point. The longitudinal axis 1504 is from the midpoint of the bottom 1501 to the midpoint of the top 1502, and may be normal to the support or at another angle. The top 1502 can be perpendicular to the longitudinal axis or at an angle, and can be flat, contoured or some other shape. Between the top 1502 and bottom 1501 are the lateral sides 1503.

The lateral sides 1503 can be parallel to the longitudinal axis or at an angle to it, and they can be straight longitudinally or non-straight (the lateral sides of the DQ grip 1500 are curved and concave). The lateral sides 1503 can be symmetrical about the longitudinal axis or asymmetrical. The length (longitudinal dimension) or height 1507 of the DQ grip in the following is the amount the DQ grip projects out from the support 1506 to which it is attached. The height 1507 is measured from the support 1506 to the point on the top 1502 farthest from the support. In the following, the cross-sectional dimensions of a DQ grip are measured parallel to the direction of force 1508 that will act on a door, window or drawer to open it, which is generally roughly perpendicular to the longitudinal axis; in FIG. 15, the cross-sectional dimension of the top 1502 is shown by the line 1505. The cross sectional shape of a DQ grip can be a regular polygon, circular, oval, rectangular, irregular or any of a myriad of shapes. Some forms of DQ grips are preferable to others as will be pointed out below. DQ grips can have many shapes and forms and so the preceding description of the terms should not adversely constrain the design of DQ grips. The direction of force to open a door is parallel to the direction the door moves, which is generally perpendicular to the surface of a hinged door, and horizontal and parallel to the surface of a sliding door.

In a preferred embodiment, the lateral sides of a DQ grip are are no higher than what can be covered by wrapping a pinky around the DQ grip, and the DQ grip is small enough in girth (i.e., the circumference measured around the lateral sides) that the pinky can be wrapped around the DQ grip far enough for the tip of the pinky to touch the palm or be close to touching the palm (generally at least about ¾ of the way around the DQ grip). Pinkies and hands vary in size from person to person, so to design a DQ grip that will meet the preceding criteria for the majority of adults using it, an average-sized adult pinky can be used (the size of an average adult pinky can be determined by sampling the relevant adult population) as the standard for determining the appropriate dimensions; it may be advisable to use a smaller-than-average-size adult pinky as the standard to increase the portion of the population for which a DQ grip provides a comfortable and sanitary way to open a door. Also, in some embodiments the DQ grip's girth may vary between its attached and free ends; in this case, the girth at the free end determines to a large extent how well the pinky covers the DQ grip, and the girth near its midsection (midway between the free and attached ends) determines how well the DQ grip can be grasped.

When using a DQ grip, a person's finger will apply most of the force necessary to open the door to only a portion of the lateral side's surface. The portion of the DQ grip's lateral sides against which most of the force to open a door is applied will be referred to as the pulling surface. Preferably, the pulling surface is relatively smooth or continuous (e.g., no sharp or pronounced edges). Such a pulling surface will be more comfortable that one that has edges, for instance. The pulling surface can conform more or less to the shape of palm and pinky where they are in contact with the DQ grip. It is well-known how to design handles for tools and other devices so that they are comfortable to operate even when applying a significant force, and such knowledge can be applied to the design of DQ grips to make them comfortable to use with a pinky.

A person using a DQ grip will generally wrap his pinky around the DQ grip while closing the rest of his fingers into a full (all fingers) or partial (only some fingers) fist. Although the pinky when used alone is generally the weakest of the fingers, an object with a sufficiently small cross-sectional dimension can be very securely gripped by the pinky alone when it is curled sufficiently far around the object, especially when the other fingers are curled with it to form a fist. The cross sectional size or girth of a DQ grip is preferably sufficiently small to allow it to be grasped relatively securely enough by an average-size pinky to be used to open a door. The girth of a DQ grip can be larger, but comfort and ease of use will be sacrificed to some extent. For example, a cylindrical DQ grip two inches in diameter will be harder to grasp securely than one five-eighths of an inch in diameter, because the former's circumference is over six inches while the latter's is only two inches; an average adult pinky is less than three inches long so it can only wrap part of the way around the 2 inch DQ grip while it can wrap all the way around the smaller, ⅝ inch, DQ grip.

In preferred embodiments, a DQ grip has a small enough cross-sectional dimension that it allows significant bending of the first two joints of the pinky (the metacarpophalangeal and proximal interphalangeal joints)—this helps one obtain a strong and comfortable grip, and allows the rest of the pinky (i.e., its intermediate phalange and distal phalange) to wrap more or less completely around it, but does not have such a small cross-sectional dimension that the pulling surface is so small that it is painful to pull on.

A DQ grip with a maximum cross section of no more than about ½″ or ⅝″ is desirable, although DQ grips with a maximum cross section of a ¾″ or 1″ or even larger will also work. However, a DQ grip with a large cross section will generally have a top that is large in area, and a large top will be harder to isolate completely from other parts of the hand; in other words, the pinky may not be able to fully isolate the DQ grip from the rest of the hand simply by wrapping around it.

DQ grips with smaller cross-sectional dimensions such as 0.375 inch or even 0.25 inch can be comfortable to use for opening most doors or drawers if they are properly designed, and the smaller size will reduce the amount of skin that comes into contact with a germ carrying surface. If a DQ grip does not have a roughly consistent cross section over its entire length (for example, it is conical), the cross section at the bottom of the DQ grip may be larger than the dimensions discussed above without reducing the comfort or ease of use of the DQ grip. The bones and joints of the pink are solid and cannot shift as can the muscle and skin of the pinky. Therefore, the cross-sectional size, surface smoothness and shape of a DQ grip in those portions of it lateral sides against which the bones and joints of the pinky will press are important for comfort and ease of use; this will vary with finger size but for an average size adult pinky, this will generally be from about ⅛ inch from where the pinky presses against the support to about ½ inch from the support. Again, it is well known how to make handles (such as for tools or doors) for comfortably grasping with multiple fingers and applying a force, and it will be obvious to those skilled in the art of designing such handles how to use the same design principles to make a DQ grip that is comfortable to grasp with the pinky alone and apply a force.

For comfort it is preferred that any large transverse notch (a transverse notch 1510 is shown in FIG. 15) be wide enough (the width dimension of the notch 1510 is indicated by line 1511) that a pinky can fit into it comfortably (for example, between about ⅜ and ½ inch wide for adult pinkies) but not so deep that its sides will pinch the pinky (if the notch is deep, the sides will be steep, and the force of the notch sides will be pressing more against the lateral sides of the pinky and less against its front side). It is preferred that the sides or side (if circular) of the notch are smooth. This is consistent with the design of handles gripped in a fist, such as the plastic handles that slip over the ends of handle bars of children's bicycles; there is a single large notch for each finger to help hold them on the grip, and since a DQ grip is made to be grasped solely by a single finger, there should be only one large notch to help hold that finger on the DQ grip. The notch can continue completely around the lateral sides of a DQ grip, or can only be in part of the lateral sides, such only on the pulling surface side of a DQ grip (the notches of the aforementioned bicycle handles are only on one side). Wide notches preferably have a continuous concave side or, if the notch has multiple straight sides, the sides preferably form a concave portion of a convex polygon (in a convex polygon no non-tangential straight line drawn through any one point in the sides of the notch will intersect with more than one other point). If notches are too narrow for a pinky to fit into comfortably, it is preferred that they be small enough that little of the pinky or its flesh can fit into it, and that their edges, and any ridges between multiple notches be smooth or convex so that they be comfortable to press against. In this case, the notches will likely be mostly for improving grip by providing a roughened surface (the surface of a DQ grip can also be roughened in other ways for better grip). However, since pits, diamond patterns, crevasses or narrow notches can be difficult to clean completely and can therefore collect microbes, and dirt and grease where microbes can grow, it is preferred that DQ grips have smooth and continuous surfaces with no crevasses, pits, sharp interior corners or other places that cannot easily be cleaned.

Because many doors pivot around hinges, unless a person continually shifts the position of his body or arm, a DQ grip will tend to pivot in his pinky as he pulls the door open. This will often also be the case with sliding doors. Moreover, the pulling surface will tend to change (the force may start being applied perpendicular to the door's surface but it may be applied at an ever increasing angle as the door swings wider open). In order that it is easy and comfortable for the DQ grip to rotate relative to the pinky and palm, in some preferred embodiments the DQ grip has a circular cross section and smooth lateral sides. DQ grips with circular cross sections include cylindrical, hemispherical, hourglass-shaped (see the DQ grip 1500 in FIG. 15), and conical DQ grips. For the same reason, the handles of large door pulls usually have grips with circular cross sections and smooth surfaces.

A DQ grip must be made of a material sufficiently strong to withstand the range of forces that will be applied to it when opening the door to which the DQ grip is attached. The materials used to make the door openers to which the DQ grips are attached can be used for the DQ grip as well. These include metals (such as steel, stainless steel, brass and aluminum), plastics and wood. Although skin contact is minimized by using a DQ grip to open a door, some germs may still be transferred from one person to another via the surface of the DQ grip. In order to minimize the number of germs transferred, the DQ grip in some embodiments has a surface layer that is anti-microbial. The anti-microbial layer can comprise a material, such as silver or copper or oxide, with anti-microbial properties, or a region having a morphology that resists microbe growth and attachment, or it can be an active layer or coating with electrical, chemical or optical activity that kills microbes or discourages their growth. Much research has been done on such surfaces, including in designing biocidial and other biological-entity-resisting coatings for the hulls of ships and in designing anti-microbial surfaces for medical instruments, and the fruits of this research can be applied to make DQ grips which are less likely to harbor or transfer germs. In one embodiment, the surface layer is transmissive to UV light and a UV source is incorporated into the support to which the DQ grip is attached or into the DQ grip itself such that it transmits UV light into the transmissive surface layer so that microbes on the outer surface of the transmissive layer will be exposed to UV radiation and killed (UV light of the proper wavelengths kills many microbes).

Since people will reach for a DQ grip carelessly, it is preferable that the DQ grip be shaped so that it will not injure an errant hand which grasps it incorrectly. It also preferably does not catch easily on the clothes or bodies of people who brush past it. A very thin DQ grip, especially one with relatively sharp edges between the top and lateral sides, may puncture a hand that carelessly and with too much force reaches for it. A conical DQ grip with a sharp top may do the same. A free end that is at least slightly rounded will resist catching on people's clothes as the brush up against it. Lateral sides that slope slightly inwards towards the free end will have the same effect.

The pulling surface of a DQ grip (and the pushing surface, that surface against which a pinky will push if the DQ grip is used to push open a door) is preferably of sufficiently large area that applying the necessary force to open the door does not cause discomfort to the person using it (for example, if that surface is very thin or pointed, the force to open the door will be concentrated on a small area of the pinky and may cause discomfort). If the pulling (or pushing) surface has any edges, they are preferably rounded to avoid creating pressure points. The shape of the pulling (or pushing) surface is also important. For example, a cylindrical DQ grip that is ⅛ of an inch in diameter will be more comfortable to use than a square DQ grip that is ⅛ of an inch on a side. It is well known how to make comfortable handles and that knowledge can be applied to design DQ grips that are comfortable to use to open various size doors.

Because the person's pinky will be applying most of the force necessary to open a door against the pulling surface, the pulling surface of the DQ grip is by definition oriented roughly orthogonal to the direction of the force vector required to pull open the door. For example, if the door is a planar hinged door, this force vector is orthogonal to the surface of the door because a person pulls the door straight out from its frame to open it, at least initially, and if the door is a sliding door, this force vector is parallel to the direction of sliding because a person pulls it along a track to open it. The pulling surface of a DQ grip can be shaped to enhance the ability of people to securely grasp the DQ grip with their pinky, while not creating a risk of injury to the pinky if the door is opened from the other side while the DQ grip is being used (i.e., the finger won't get stuck in the DQ grip as it might if, for instance, the pulling surface was a deep concavity). A slight cant of the pulling surface towards the door (against the direction of pull) or a slightly concave pulling surface will tend to hold the pinky on the DQ grip when a force is applied. The concavity need not be very deep (the depth of the concave notch 1510 shown in FIG. 15 is indicated by the line 1512) to achieve its purpose; ⅛ to ¼ inch is sufficient. A small rounded flange projecting 1/16 or ⅛ inch out from and roughly perpendicular to the lateral sides adjacent to the top side of the DQ grip will achieve the same purpose of keeping the pinky from slipping off the DQ grip, and it will accomplish this purpose if it is only on the side facing towards the direction of force to open the door. Conversely, a pinky may have a tendency to slip up and off a DQ grip if the DQ grip is canted away from the door or has a convex pulling surface.

The distance a DQ grip projects out from the support (its height or longitudinal dimension) is preferably less than the width of a pinky measured across the proximal phalange. For an average-size adult, this is between about ½ inch and about ¾ inch. If it is less than about ¾ inch in both height and maximum transverse width, generally only the pinky of an adult with average-size hands will come into contact with a DQ grip when it is being used to open a door. Even if a DQ grip is slightly higher than the width of the pinky grasping it, the flesh of the pinky will tend to spread out when it applies a force to the DQ grip, and this will tend to keep the ring finger from coming into contact with the top of the DQ grip, and even if a part of the ring finger does graze the top of the DQ grip, the only contact is likely to be with the skin between the ring finger and the pinky, an area of the hand that rarely comes into contact with the eyes, nose or mouth. However, because their hands, and pinkies, are smaller, a different portion of the ring fingers of children and adults with small hands may come into contact with the top of a DQ grip designed for average adults. Even if the free end of a DQ grip comes into contact with a portion of the ring finger, the DQ grip will still be more sanitary and do a better job preventing the spread of germs than a normal door handle.

In addition to preferably not being too high, a DQ grip is preferably be high enough that an adult can comfortably grip it and apply sufficient force to open the door to which it is attached. Preferably, a DQ grip is high enough that the force is applied to the DQ grip by the intermediate and/or proximal phalange. In this case, the bones of the pinky provide a rigid flesh-covered structure that can apply a force against the DQ grip. This height is approximately 0.5 inch for an adult finger. The height of the DQ grip is preferably such that the force applied to open the door will be transferred directly (in the direction of the force) from the bones of the pinky and through the pinky's flesh to some portion of the DQ grip. However, by pressing down on the support and pulling on the DQ grip at the same time, even a very low DQ grip (for example, even one ¼ or ⅛ inch high) can be used to open a door. With very short DQ grips the force may be applied only by the flesh at the edge of the pinky while with slightly taller DQ grips the bones of the pinky may be behind at least some of the flesh applying the force. The finger will have a tendency to slip over and off a short DQ grip; pushing down while pulling helps prevent this from occurring. The height of a DQ grip is preferably between about 0.375 inches and about 0.75 inches (or between about 0.25 inches and about 0.875 inch; or between about 0.25 and about 0.75 inches; or between about 0.25 inches and about 0.625 inches; or between about 0.375 inches and 0.625 inches; or between about 0.25 inches and 0.5 inches; or between about 0.375 inches and 0.5 inches; or between about 0.125 inches and 0.75 inches or between about 0.125 inches and 0.625 inches or between about 0.25 inches and 1.0 inches or between about 0.375 inches and 1.0 inches).

In preferred embodiments, when mounted to a door a DQ grip is projecting from the support at an angle between vertically upwards and horizontal in either direction (this is 180 degrees above and including the horizontal) so that a person will be able to grasp the DQ grip with his hand vertical with the thumb up or horizontal with the palm up or down. These are comfortable positions for the hand in general and specifically for the hand to pull in. However, since with the palm facing down it is comfortable to rotate the wrist about 45 degrees down from horizontal (thumb moving down), a DQ grip at up to about at 45 degree angle down from horizontal will be relatively comfortable to use with the palm down and the pinky higher than the thumb. Rotating the wrist with the palm up past horizontal is uncomfortable, so using a DQ grip at an angle 45 degrees below horizontal with the palm up will be uncomfortable. DQ grips oriented between horizontal and vertically with the free end up will be relatively comfortable to use with either hand (one with the palm facing one way, the other with the palm facing the opposite way), while a DQ grip pointing somewhat downwards will generally only be comfortable using whichever hand can grasp it with the palm down.

A DQ grip can be attached to a support (such as a prior art door opener) at many places on the support. Preferably a DQ grip attached at a location on the support such that when the support is attached to a door, the DQ grip is at a height above the ground that is within easy reach of most people using the door and at a height where the DQ grip is comfortable to use. A DQ grip will generally be comfortable and easy for most people to use if it is at the same height above the ground as that at which door openers are generally mounted.

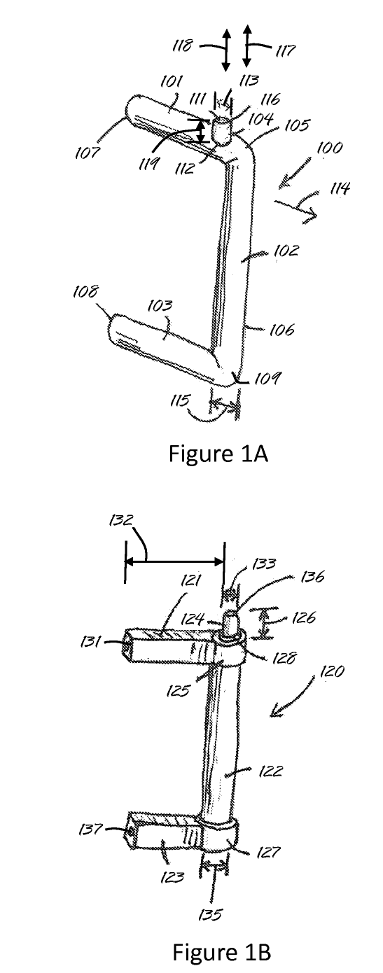

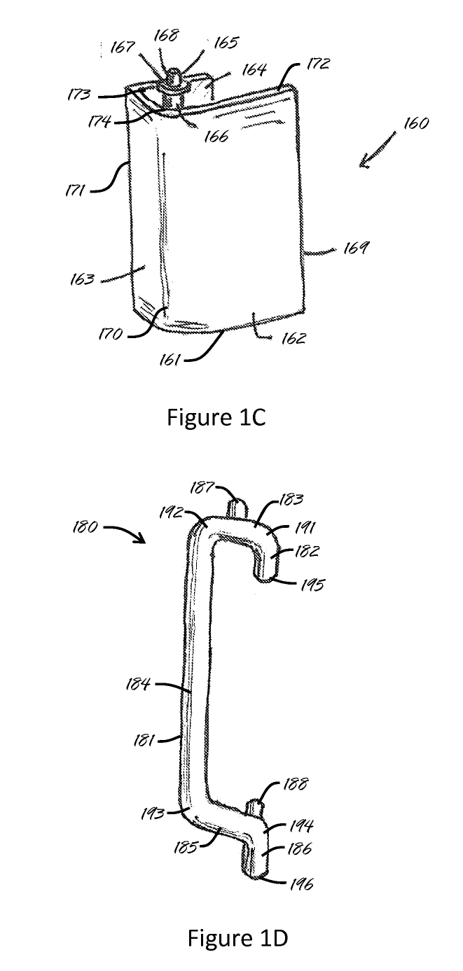

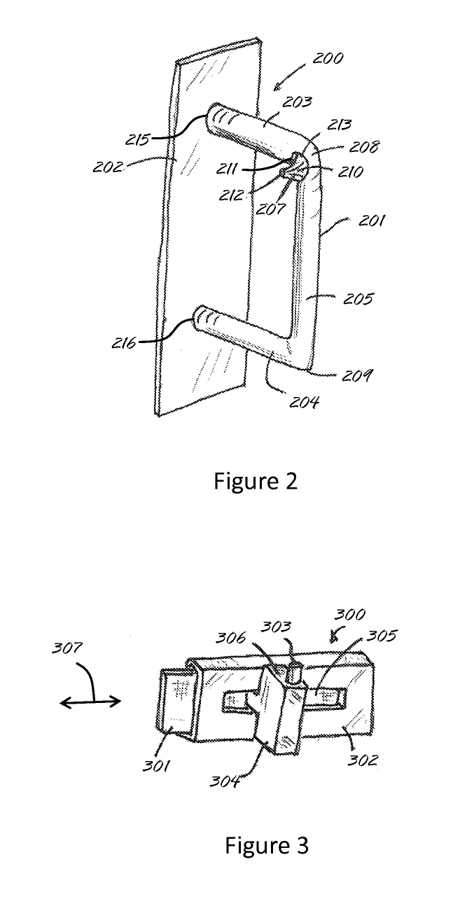

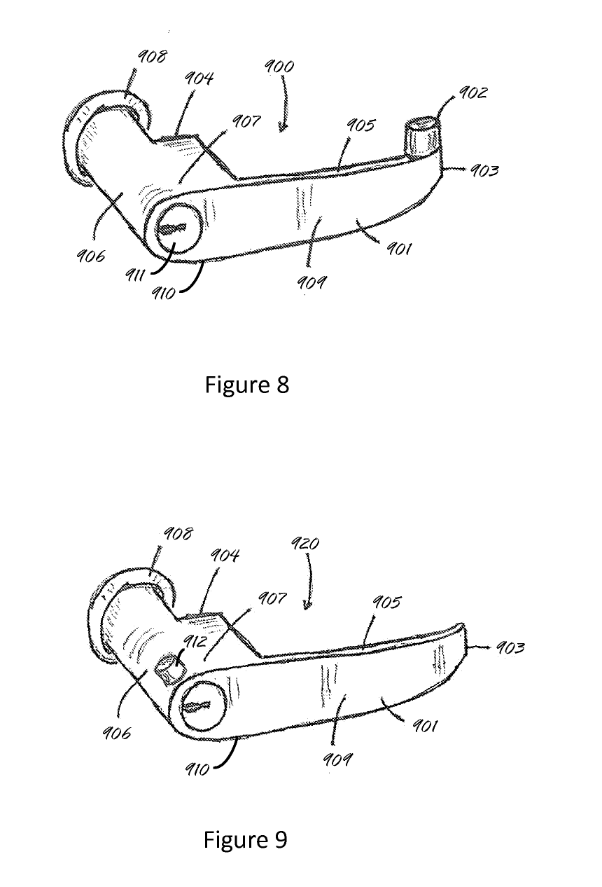

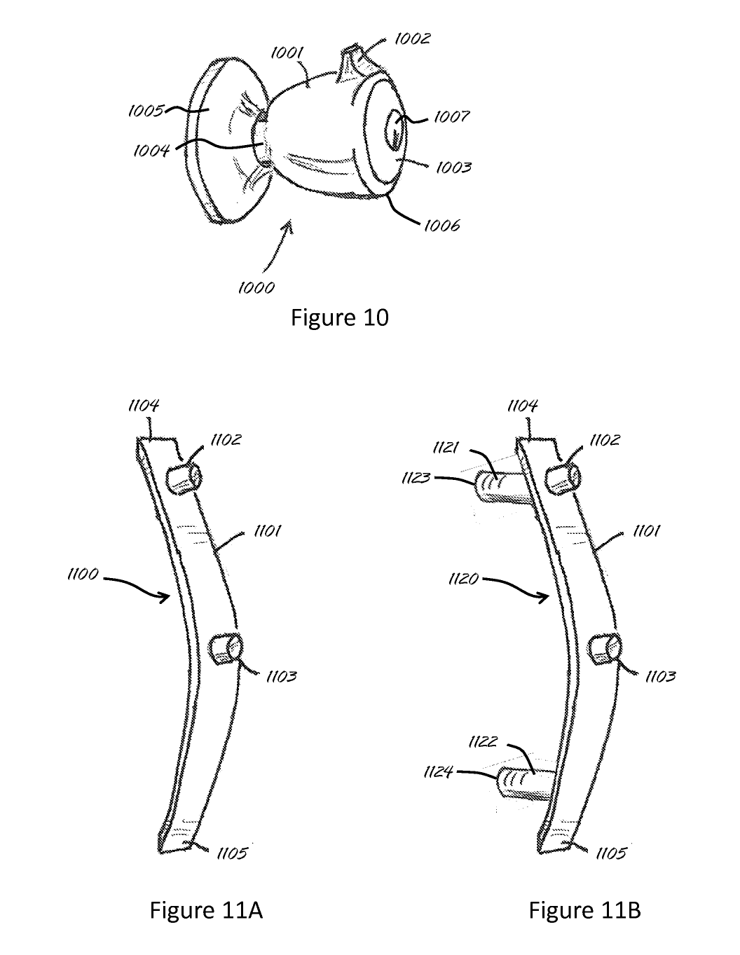

If the support for a DQ grip is a door opener incorporating a first handle, the DQ grip, which will be the second handle, is preferably incorporated into the door opener in such a way that the door opener's first handle can be used as it would normally be used in absence of the DQ grip. For example, the DQ grip 104 of the pull door opener 100 in FIG. 1A is located on a support 101, leaving the hand grip 102 completely unchanged. The same is true for the DQ grips in FIGS. 1B-1D, and FIG. 2. FIGS. 8 and 9 show lever-type door openers which incorporate DQ grips. The door opener 900 in FIG. 8 has a DQ grip 902 incorporated into the end of the lever 901, which may interfere with use of the handle 901 somewhat, while the DQ grip 912 that is incorporated into the door opener 920 in FIG. 9 is incorporated into the base 906, leaving the lever handle 901 unaffected. The door opener 600 in FIG. 7 has a DQ grip 605 incorporated into its latch release tab 604 in such a way that it does not overly interfere with use of the tab release 604. A DQ grip 1002 is preferably incorporated into the knob 1001 of the knob-type door opener 1000 in FIG. 10 so that it interferes as little as possible with normal use of the knob 1001 (e.g., at the best angle and set back from the outer edge of the knob). With regards to the door opener 1100 in FIG. 11A, while the first DQ grip 1102 is located away from the central part of the handle 1101 that is most commonly used when grasping with a full hand, the second DQ grip 1103 may interfere somewhat with grasping the handle 1101, and in some embodiments, it may be desirable to eliminate the second DQ grip 1103 from the sliding door opener 1100 (and also from the similar door opener 1120).

In order to minimize contact between the person and any surface that can transfer germs, a DQ grip should have enough empty space around it for a person to be able to grasp the DQ grip without touching another surface except the support. For example, a DQ grip incorporated into a door pull should be attached to the pull at a location that will be far enough away from the door when the pull is mounted to a door that a user can grasp the DQ grip without touching the door with any part of his hand. Likewise, there should be sufficient space around a DQ grip for a person to reach for and grasp it without touching another surface; for example, there should be sufficient space above and horizontally around a vertically oriented DQ grip that a person can grasp and use the DQ grip without touching anything other than the DQ grip itself and the support to which it is attached. In one embodiment, the distance between the DQ grip and the door is at least one of the following: 1″, 1.5″, 2″, 2.5″ and 3″.

Some door openers into which one could incorporate a DQ grip and which will serve as its support have elements, such as a housing or decorative cover, that extend away from the surface of the door and may result in there not being enough distance between the DQ grip and that element to prevent hand contact with the element when using the DQ grip. If this is the case, a cantilever can be attached to the door opener support at one end and the DQ grip can be attached to the cantilever at its other end, thus increasing the distance between the DQ grip and that part of the door or door opener support that would have been too close if the DQ grip was mounted directly to the door opener support. In one embodiment, the distance between the DQ grip and any other part of the door opener along a line perpendicular to the surface of the door is at least one of the following: 1″, 1.5″, 2″, 2.5″ and 3″.

In addition, the shape and dimensions of the support at and adjacent to the point at which a DQ grip is attached and from which it outwardly projects will have an impact on how much of the user's hand touches a potentially germ-carrying surface. If a DQ grip projects up from the center of a large flat support, much if not all of the outer edge of a user's hand will be in contact with the support, whereas if the DQ grip is attached to a narrow upper support of a door pull, a smaller portion of the edge of the hand will be in contact with the support when the DQ grip is used. Attaching a DQ grip at or near the edge of a support away from the door so that when the DQ grip is used the edge of the user's palm will mostly be suspended over free space will also help minimize skin contact with the support; in this case only the outer edge of the pinky may be in contact with the support and no part of the edge of the palm except perhaps that part immediately adjacent to the base of the pinky will be touching anything.

In some cases it may be desirable to design a two-finger grip that can be grasped by wrapping both the pinky and ring finger around the two-finger grip so that those two fingers together will pull or push to open or close a door (three-finger grips long enough to be grasped using the middle finger as well as the pinky and ring finger can also be made). The two-finger grip length will be greater, between approximately 0.75 inch and 1.5 inch, and preferably between approximately 1 inch and 1.5 inch. However, it is important to remember that the longer the finger grip, the more of the hand is in contact with it during use, and the more opportunities there are for germs to be transferred from the finger grip to the person. Many of the design considerations for a DQ grip apply to a two-finger grip. It is important to note that since fingers vary greatly in size, a DQ grip for adults may be a two-finger grip for a small child. However, in preferred embodiments for adults, DQ grips are designed and sized so that when operated by an adult having a pinky that is not too much smaller than an average adult-sized pinky, that person's pinky will be the only finger touching the DQ grip. In preferred embodiments for children, the size of the DQ grip will be enough smaller that the child's pinky will be the only finger touching the DQ grip when it is used.

In summary, a DQ grip should be sized and shaped to be safe and comfortable to use while limiting contact between the user's hand and potentially germ carrying surfaces as much as possible, preferably just to the pinky of the hand using the DQ grip to open a door. Following are descriptions of various embodiments of the present invention. The preceding design considerations apply to these embodiments.

FIG. 1A shows a door opener 100 comprising a DQ grip 104 and a U-shaped handle 106, the legs of the U being two elongate cylindrical, roughly parallel and roughly equal-length mounting supports, first support 101 and second support 103, with the base of the U formed by an elongate cylindrical crosspiece handle or hand grip 102 which is attached or connected at its first and second ends to a first end of each support (101 and 103). The crosspiece 102 serves as a hand grip when the handle 106 is used in the typical manner (a person wraps his four fingers around one side and his thumb around the other side of the crosspiece 102). When the pull 100 is mounted to a door, the hand grip 102 will typically be vertically oriented with the first support 101 on top and the second support 103 below it (when mounted to a drawer, the crosspiece 102 may be horizontal). The two supports 101 and 103 are used to mount the pull 100 to a door, and have second, free ends 107 and 108 respectively which have threaded holes in their ends (not shown) aligned with the axes of the supports 101, 103 so that bolts can be pushed through holes in the door from the opposite side and screwed into the threaded holes.

In the embodiment shown in FIG. 1A, the U-shaped handle 106 is formed from a single or unitary tube, bar or rod which is bent at each end to form the two equal-length and parallel legs or supports 101 and 103, with an upper bend or elbow 105 where upper, first support leg 101 and a first end of the crosspiece 102 meet, and a lower bend or elbow 109 where the lower or second support leg 103 and a second end of the crosspiece 102 meet. Many U-shaped pulls in current use are similarly constructed. The length of the supports can be considered to be the distance from the point of attachment to the door to the beginning of the bend, and the distance of the handle 102 from the door will be the length of the support plus the radius of the bend. Alternately, the two legs 101 and 103 and the crosspiece 102 can be separate components that are attached to one another to form the U-shaped handle 106, such as by fasteners, welding or gluing.

The following assumes the pull door opener 100 is installed in a typical orientation, with the first support 101 on top and the crosspiece 102 vertically oriented. The door opener 100 also comprises a DQ grip 104, which is attached at a first base end 112 to the first support 101 proximal to the upper elbow 105, and which projects or extends from the support 101 roughly parallel to the crosspiece 102 (vertically in this orientation of the pull 100). In the embodiment shown in FIG. 1A, the DQ grip 104 is roughly cylindrical in cross section, although it has a different form in other embodiments. The longitudinal axis 118 of cylindrical DQ grip 104 and the longitudinal axis 117 of the crosspiece 102 are parallel but not aligned (their respective longitudinal axes are offset, with the DQ grip's axis 118 closer to the door; both longitudinal axes 117 and 118 are vertical when the pull door opener 100 is installed in the typical orientation). In other embodiments, the axes 118 and 117 of the DQ grip 104 and the hand grip 102 respectively are aligned. In some embodiments, the axes are not parallel; in one embodiment the axis 118 of DQ grip 104 is tilted such that the free end 116 of the DQ grip 104 is closer to the door than the base end 112 where it is attached to the first support 101. In one embodiment, the first support 101 is longer than the second support 103 and cantilevers to a new free end beyond the crosspiece 102 (the length of the two supports 101 and 103 between the elbows 105 and 109 and their respective mounting ends 107 and 108 remains the same) and the DQ grip 104 is attached at the new free end of the support 101, projecting upwards (or between vertically upwards and horizontal to either side).

The cross-sectional dimension (width or thickness) 113 of the DQ grip 104 can be the same as or different from the cross-sectional dimension 115 of the hand grip crosspiece 102; in the embodiment shown in FIG. 1A, the DQ grip's cross section 113 is smaller. Because the fingers and thumb work together to grasp a hand grip such as crosspiece 102, a relatively thick crosspiece 102 (1″ or 1.25″ or 1.5″) will still be comfortable to use for most people while a similarly sized DQ grip may be uncomfortable for many to grasp using only the pinky. In one embodiment, the second leg 103 is removed and the crosspiece hand grip 102 has a free end where the lower elbow 109 would have been.

While the U-shaped handle 106 is symmetric around a perpendicular axis through the midpoint of the crosspiece 102 and parallel to the support legs 101 and 103, the pull 100 is not symmetric around the same axis due to the DQ grip 104; there is not a second element equivalent in size and form to the DQ grip 104 attached to and projecting downwards from the second leg 103 proximal to the elbow 109. The pull 100 is a U-shaped handle 106 with a single element that serves as a DQ grip projecting from it. In one embodiment, there is a second element roughly identical in form and size to the DQ grip 104 and extending downwards identically from the second leg 103.

The DQ grip 104 is intended to be grasped using just the pinky (at least by most of those in the group expected to use it). In this embodiment, a person operates the pull 100 by wrapping his or her little finger at least partly around the DQ grip 104 and pulling away from the door in direction 114 (i.e., in the direction he or she wants the door to move).

The height 119 of the DQ grip 104 can vary, but the height is preferably not much more than the width of an average-size adult pinky (measured at the proximal phalange) or about 0.5 to about 0.625 inches or even 0.75 inches; this height enables the pinky to obtain a secure grip but also to keep the ring finger from touching the top of the DQ grip or any portion of its lateral sides. The cross-sectional dimension 113 of the DQ grip 104 can also vary, but for comfort and usability it is preferably between about 0.25 and 0.5 inches. The free, top end 116 has rounded edges for comfort.

The DQ grip 104 is attached to the first leg 101 far enough from the point at which the leg 101 is attached to the door (the mounting end 107), and the first leg 101 is long enough, that a person is able to grasp the DQ grip 104 without touching the door with another part of his hand (there should generally be a bare minimum of about 1 inch between the door and the closest part of a DQ grip (at least at its top and above about ¼ to about ⅓ of the way up its length away from the support), and generally should be at least 1.5 inches, and preferably 2 inches or more).

In one embodiment, the door opener 100 is intended for mounting horizontally to a door, the length of the cross-piece handle 102 is such that the door opener spans or nearly spans the width of the door, and the DQ grip 104 is attached to or mounted on the first support 101 or handle 102 proximal to the first elbow 105 such that it extends vertically upwards. If the door is a hinged door, the first support 101 will be mounted to the door farthest from the hinged edge. If the door is a sliding door, the first support 101 will generally be attached to the edge of the door which will come into contact with some other surface to close the door way opening.

The door opener 100 will generally be used on a hinged door. However, it could also be mounted to a sliding door, although with the DQ grip 104 attached as shown in FIG. 1A the distance between the DQ grip 104 and the door would need to be close to 1.75 or 2 inches to make it easy to use the DQ grip 104 without touching the door with another part of the hand. In one embodiment, the door opener 100 is intended for mounting to a sliding door, and the DQ grip 104 is attached to the handle 102 proximal to the first elbow 105 and extending horizontally away from the door (approximately perpendicular to the door's surface). In another embodiment, the DQ grip 104 is attached to the handle 102 proximal to the second elbow 109 and extending horizontally away from the door.

Door openers of the present invention which incorporate DQ grips such as the DQ grip 104 in FIG. 1A can generally be operated in at least two ways (it can be said that door pull 100 has two grips or handles, the crosspiece 102 and the DQ grip 104). Using the door pull 100 shown in FIG. 1A as an example, one mode of operation for the door opener 100 is to grasp the crosspiece hand grip 102 with multiple fingers and pull in the direction 114 away from and more or less orthogonal to the door (this mode of operation is how U-shaped pull door openers like the U-shaped pull 106 are generally used to open a door or a drawer). A second mode of operation for the door opener 100, is to grasp the DQ grip 104 with a pinky and pull in the same direction 114. Pulls such as U-shaped pull 106 can have many sizes, but typically the smallest, intended for drawers, measure at least 2.5 inches from the inside of one support to the inside of the other, and pulls intended for use with the entire hand typically measure at least 4 inches and those used on public restroom doors may measure 7-12 or more inches. Some pulls extend from the top of a door to the bottom along its outer edge. Other pulls extend from one edge of the door to the other.

The novel door openers in FIGS. 1B-D, 2, 6, 7, 9, 10, 11, and 12A-C also have two modes of operation or use. Each of these door openers comprises one of the many types of prior art door openers currently in use, such as a U-shaped pull, a door knob or lever, a pull plate, a handle set, a push bar, a pull bar, a push-pull paddle and a sliding door handle, and a DQ grip. The door openers of the present invention are distinguished by their DQ grips which provide an alternate way (second mode) of operating the door opener. While the prior art door openers incorporated into the door openers of the present invention can come in various sizes, for doors they are typically sized so that when they are used as intended (there are often many ways to grasp a door opener, but there is typically a single intended way), they can be operated using several fingers together or an entire hand (for example, all four non-thumb fingers and the thumb, all four non-thumb fingers only, or the thumb, the index finger and one or more of the other non-thumb fingers).

Each of these door openers of the present invention has a first grip or handle that is of sufficient size that it can be operated using two or more fingers, usually by an entire hand, and has a second grip or handle so small that it cannot easily be operated only more than a single finger, the pinky. The first handles for current manual door openers are designed to be operated using the index finger in conjunction with either the thumb or other non-thumb fingers.

When the first handle is elongate and intended to be pulled upon, such as the first handles 102, 122, 184, 205, 602, 901 and 1101 of the door openers 100, 120, 180, 200, 600, 900 and 1100 respectively, the first handle is intended to be grasped by wrapping the index finger and one or more of the other three non-thumb fingers, in order (people will generally and most comfortably use the index finger and adjacent fingers [e.g., the index finger with the middle finger, the index, middle and ring fingers together, or all four non-thumb fingers] and will not skip a finger by using the index finger with a non-adjacent finger [e.g., the index and ring fingers only]), around one side of the first grip and the thumb around the other side. The first grips of these door openers will typically be at least 2.5 inches long, and preferably at least 4, 5, 6, 7 or 8 inches or longer, so that more than one non-thumb finger can be accommodated along the grip (for example, between the supports for the handle or the mounting points of the handle).

When a finger wraps around a elongate handle, a certain amount of the palmar side of that finger will be in contact with the handle. The amount depends upon the girth of the handle and how tightly it is grasped. When a finger curls into the palm, the length of the finger as measured around the dorsal or back side of the finger remains roughly the same as when the finger is straight, but the length of the finger as measured around the palmar side of the finger is dramatically reduced as the flesh along the length of the finger collapses in towards the center of the curl from all sides. As a consequence, even when grasping an elongate item having a small girth, a portion of the flesh on the palmar side of at least the proximal and intermediate phalanges, but usually also of the distal phalange and palm adjacent to the finger, will be in contact with items at various points around its girth. When grasping an elongate item (such as the handle of a pull) having a larger girth, a greater portion of the flesh on the palmar side of the three sections of the finger (first section, between the metacarpophalangeal joint and the proximal interphalangeal joint; second section, between the proximal interphalangeal joint and the distal interphalangeal joint; and third section, between the distal interphalangeal joint and the finger tip) and the adjacent palm will be in contact with the item.

When the first grip is planar, such as the first grips 162, 1221 and 1234 of the door openers 160, 1220 and 1230, the first grip is intended to be used to open a door by curling the index finger and one or more of the other three non-thumb fingers, in order and without skipping any, around behind one of the free edges of the respectively, and pulling. The free edge of these door openers that serves as the first grip will typically be 4, 5, 6 or more inches long to provide adequate space for all four non-thumb fingers.

The first handle of the door opener 1000 in FIG. 10 is a knob 1001 which can be used by wrapping the thumb and at least one other finger (typically the index finger) in opposing directions around the circumference of the knob 1001 transverse to its axis of rotation, and then pulling away from the door. The circumference of knobs such as the knob 1001 is preferably sufficiently great that the length of the thumb and fingers will not wrap all the way around the knob but not so large as to be hard to grasp with small hands. Most door knobs have a maximum diameter of between about two to three inches (circumference of about 6.25 to 9.5 inches). As such, a substantial portion, if not all, of the thumb and index finger (a portion of the flesh on the palmar side of both fingers from the metacarpophalangeal joint to the finger tip, and also of the flesh between the index finger and thumb), and potentially of one or more other fingers, are in contact with the knob when using it to open a door.

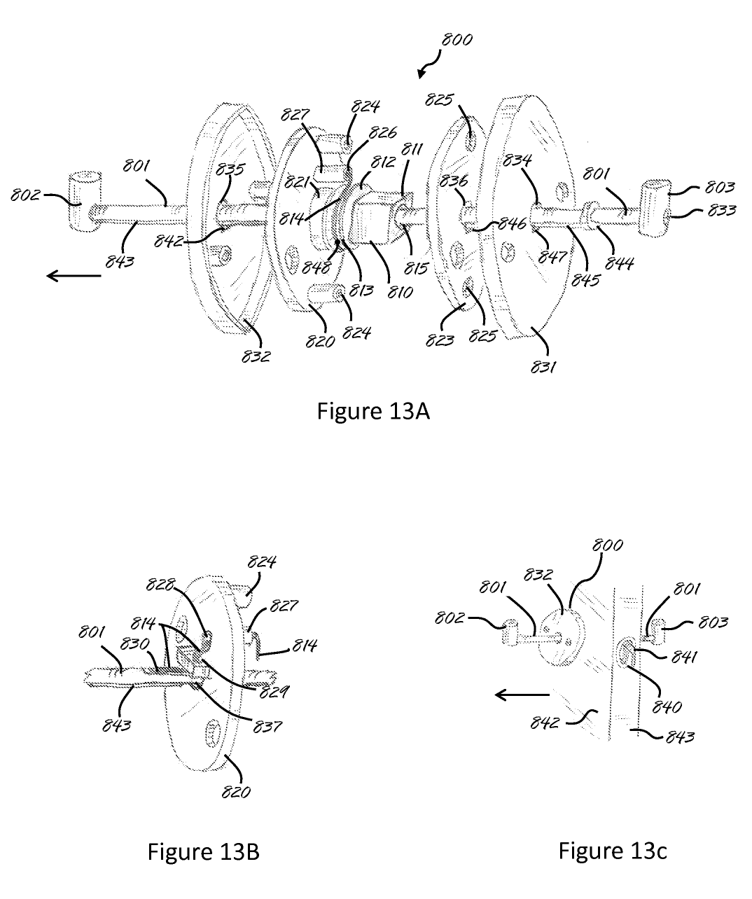

Without the DQ grip that has been added to each of the door openers described herein, the door opener would be intended to be operated as described in the preceding paragraphs. The door opener 800 in FIG. 13A is an exception because it is specifically designed so that the DQ grip is the only way to operate the door opener. In one embodiment, the length of the first grip is at least one of the following: 3″, 4″, 5″, 6″, 7″, 8″, 9″, 10″, 11″, or 12″. The second grip of these door openers is between about ⅜ and ¾ inch long and has a maximum cross-sectional dimension midway between its attached and free ends of between about ¼ and ⅝ inch.

The first handles of prior art manual door openers are designed to be operated with the four non-thumb fingers curling together in unison. If the first handle is big enough, all four non-thumb fingers will be in contact with it. If the first handle is too small to fit all four non-thumb fingers, such as a short U-shaped pull or a door knob, the four non-thumb fingers will still curl in unison, but only some of the fingers, starting with the index finger, will be in actual contact with the pull. To provide a stronger grip, the thumb may curl around some types of first handles (e.g., knobs, elongate handles) in a direction opposite to the direction the index finger curls around the first handle. The fingers are strongest and the hand is most comfortable when the four non-thumb fingers are moving in unison, so prior art door openers are designed such that they will move in unison, curling or straightening together. The hand is also most comfortable grasping objects by curling the non-thumb fingers around it when the palm is between horizontal (facing up or down) and vertical with the thumb on top. The DQ grip is intended to be grasped with the four non-thumb fingers curled in unison into a fist, and with the hand in the aforementioned position, but with the pinky taking the lead instead of the index finger. The DQ grip is designed and positioned so that a person can grasp it similarly to the way he or she grasps prior art handles, but with only the pinky actually in contact with the DQ grip. For example, when grasping the DQ grip 104 of the door opener 100 in FIG. 1 with his or her pinky the person's hand will be in more or less the same position as his or her hand would have been if he were grasping the hand grip 102 instead; with his fingers curled into a fist oriented with the palm roughly vertical with its thumb side up. When grasping the DQ grip 212 of the door opener 200 in FIG. 2 with his or her pinky, the person's hand will be in roughly the same position as it would have been if he or she was grasping a horizontally oriented pull (i.e., with the first handle 205 horizontal); with his fingers curled into a fist oriented with the palm roughly horizontal and the facing up or down. Using the horizontally oriented second DQ grip 1103 of the sliding door opener 1100 in FIG. 11, the user's hand will be in a similar position to that it would be in if grasping a horizontal pull. And when using the DQ grip 912 of the lever-type door opener 920 in FIG. 9 the user's hand will be in a fist again, but with the palm at an angle to the vertical and horizontal, roughly the same position it would be in if it were using a pull whose handle was parallel to the DQ grip's longitudinal axis. However in all cases, only the pinky will be in contact with the door opener if the DQ grip is used properly. Because the way a person grasps a DQ grip is basically the same as the way a person grasps a prior art elongate handle oriented at the same angle as the DQ grip (except of course which fingers are in contact with the handle), the DQ grip is intuitive, easy, familiar and comfortable to use.

A person can use a DQ grip improperly by grasping it with a finger other than the pinky, just as people can use prior art handles in ways other than intended, but that is not desirable, and if the finger used is not a finger adjacent to the edge of the hand (i.e., the pinky and index finger), using it will be uncomfortable and impractical. With some DQ grips, using any finger other than the pinky will be impractical. For example, grasping a vertically upwards extending DQ grip with the index finger will be quite uncomfortable for the same reason that a vertically downwards extending DQ grip will be uncomfortable to grasp with a pinky. Vertically oriented DQ grips will be the most intuitive to use correctly since to use them incorrectly will be difficult and uncomfortable. With other DQ grips, however, it will be possible to use the DQ grip comfortably, albeit not as sanitarily, with a finger other than the pinky. For example, horizontally oriented DQ grips can be grasped relatively comfortably using just the index finger. Doing so will limit how much of a person's hand is in contact with the door opener and can therefore transfer germs, but unfortunately, the part of the person's hand in contact with the door opener will be a part of the hand that frequently comes into contact with the eyes, nose and mouth, the index finger outside and front (extension of palm) and the back of the thumb (this will come into contact with the support). It is also possible to use the DQ grip by grasping it with a finger other than the index and pinky, but that will result in an unnatural grip unless a person is missing fingers at the edge of the hand.

FIG. 1B shows another embodiment a door pull incorporating a DQ grip. Door pull 120 comprises two elongate supports having square transverse cross sections, the first 121 and second 123 supports, which are of substantially equal length and parallel, and a cylindrical crosspiece hand grip 122 that is attached at substantially right angles to the two supports 121 and 123 by sleeves 125 and 127 respectively at its first 128 and second ends. The first support 121 will be the upper support when the door pull 120 is properly mounted to a door with the crosspiece handle 122 vertically oriented. Both supports 121, 123 have threaded holes (131 and 137 respectively) in their free ends that are used to mounting the door pull 120 to a door. Attached to the crosspiece 122 at its first end 128 and projecting upwards is a cylindrical DQ grip 124, which is axially aligned with the cylindrical hand grip 122. The cross-sectional dimension 133 of the DQ grip 124 is not the same as the cross-sectional dimension 135 of the crosspiece 122; in this embodiment the DQ grip 124 is smaller in diameter than the crosspiece hand grip 122. The DQ grip 124 can be attached to the end 128 of the crosspiece 122, such as by welding or adhesive or mechanically, or it 124 can be an integral extension of the crosspiece 122 beyond the first sleeve 125. In other embodiments, the cross-sectional dimension 133 of the DQ grip 124 is larger or the same as that 135 of the crosspiece 124. The crosspiece 122 ends at the first 125 and second 127 sleeves. In one embodiment, an element identical to the DQ grip 124 extends from the lower end of the crosspiece 124 in the same way the DQ grip 124 extends from the upper end of the crosspiece 124 so that the DQ grip 122 and the extending element are symmetric around the midpoint of the crosspiece hand grip 122. In one embodiment, the DQ grip 124 has slightly concave sides to give it an hourglass shape.

The distance 132 from the inner side of the DQ grip 124 (i.e., the side closest to the door when mounted) and the door is preferably great enough that a person can use the DQ grip 124 without touching the door with any part of his or her hand. In general this must be at least 1 inch, but is preferably at least 1.5 inches or 2 inches and over.

FIG. 1C shows a door opener 160 comprising a pull plate 161 and a DQ grip assembly 165 attached to and projecting upwards (when installed to a door) from the pull plate 161. The pull plate 161 comprises a rectangular planar grip or handle 162 having one long free edge 169 and attached at a roughly perpendicular angle along the other and opposite long edge 170 to one long edge 170 of a rectangular side plate 163 which is attached at its opposite long edge 171 at a roughly perpendicular angle to one long edge 171 of a rectangular mounting plate 164 which is mounted to a door. The pull plate 161 can be made from a single rectangular plate of a bendable material such as steel or aluminum, and can be bent into a U, with the planar grip 162 forming a first leg of the U, the side plate 163 forming the base of the U, and the mounting plate 164 forming the second leg of the U, with a first roughly right-angle bend 174 between the planar grip 162 and side plate 163, and a second roughly right-angle bend 173 parallel to the first bend between the side plate 163 and mounting plate 164.

The side plate 163 supports the planar grip 162 away from and roughly parallel to the surface of the door to which the pull 160 is mounted, and functions as a handle which can be gripped by any of its three free edges. A DQ grip assembly 165 is attached inside the angle 174 between and formed by the planar grip 162 and the side plate 163 at the planar grip's upper edge 172. The DQ grip assembly 165 comprises a cylindrical base 166 which is attached at a first end to the planar grip 162 and side plate 163, and a cylindrical DQ grip 168 attached to the base 166, and a flange 167 extending outwards from the point where the base 166 and DQ grip 168 meet. The base 166, circular flange 167 and DQ grip 168 are axially aligned. The DQ grip assembly 165 is designed so that the flange 167 keeps a pinky grasping the DQ grip 168 from touching the base 166, the planar grip 162 or the side plate 163, and provides a smooth support surface for the pinky. DQ grip assemblies such as this can be incorporated into any device operated using a hand-operated lever to make it easy to use the lever with only the pinky. In one embodiment of door opener 160, the DQ grip assembly 165 is attached at the upper edge 172 of the planar grip proximal to its outer, free edge 169. In one embodiment, the DQ grip assembly 165 consists solely of a DQ grip.

The door opener 180 shown in FIG. 1D comprises a pull handle 181, a cylindrical first DQ grip 187 and a cylindrical second DQ grip 188. The pull 181 comprises an elongate cylindrical rod formed to provide a straight crosspiece handle 184 cantilevered from a first 182 and second 186 mounting legs by a first 183 and second 185 handle support. The first 182 and second 186 mounting legs are straight, parallel, equal length and cylindrical, and have first, free ends 195 and 196 respectively which are adapted for mounting to a door so that they are both extending out roughly perpendicular to the surface of the door (such as by having a longitudinal threaded hole into which a bolt that passes through the door can be screwed; it is well known how to mount similar pulls), and have second ends that end at a first roughly right-angle elbow 191 between the second end of the first mounting leg 182 and a first end of a first handle support 183 and a second equal-angle elbow 194 between the second end of the second mounting leg 186 and a first end of a second handle support 185 such that the two handle supports 183 and 185 are parallel. A third roughly right-angle elbow 192 is formed between the second end of the first handle support 183 and a first end of the crosspiece handle 184, and a fourth roughly right-angle elbow 193 is formed between a second end of the crosspiece handle 184 and the second end of the second handle support 185. The first elbow 191 and second elbow 194, which are parallel, are in a plane roughly perpendicular to the third elbow 192 and fourth elbow 193, which are formed in opposite directions with the third elbow 192 bending down from the first handle support 183 and the fourth elbow 193 bending up from the second handle support 185. The pull 181 can be formed from a single elongate rod that is bent at the appropriate places and angles to form the four elbows, the two mounting legs, the two handle supports and the crosspiece handle as in the embodiment shown in FIG. 1D, or it can be formed from separate elongate elements that are attached at their ends to form the elbows.

The first mounting leg 182 is above the second mounting leg 186 when the door opener 180 is mounted properly to a door, and the crosspiece handle 184 is vertically oriented. When the door opener 180 is properly mounted to a door, the first DQ grip 187 extends upwards from the middle of the first handle support 183, and the second DQ grip 188 extends upwards from the middle of the fourth elbow 194, with both of their longitudinal axes roughly parallel to both the handle 184 and the surface of the door. The mounting legs 182 and 186 are preferably long enough (at least about 1.5 inches) that the second DQ grip 188 is far enough from the door when mounted that a person can grasp the second DQ grip 188 without touching the door's surface with his knuckles, and the second handle support 186 is preferably long enough (at least about 2 inches) that a person can grasp the second DQ grip 188 without his hand touching the crosspiece handle 184. Because of its open design, it is possible to attach a second DQ grip 188 within the pull 181 which can be used by children and shorter adults, and given that children and small adults typically have smaller hands, the transverse diameter of the second DQ grip 188 can be smaller and its length shorter (for example, ⅜ inch long and ¼ inch in diameter) than those of the first DQ grip 187 (for example, ⅝ long and ½ inch in diameter) which will likely be used by people with larger hands, although both can be the same size (for example, between ¼ and ½ inch in diameter and between ⅜ and ⅝ inch long). In one embodiment, the door opener 180 incorporates only the first DQ grip 187 and not the second 188. In one embodiment, the door opener 180 incorporates only the second DQ grip 188 and not the first 187.

To open a door to which the door opener 180 is mounted, a person can grasp the crosspiece handle 184 or either handle support (183 and 185) with his hand, or grasp either the first 187 or second 188 DQ grip with his pinky, and then pull.

FIG. 2 shows pull plate door opener 200 which comprises a U-shaped pull handle 201 attached to one side of rectangular planar plate 202, and a DQ grip 207 extending horizontally from the U-shaped pull handle 201. The U-shaped pull handle 201 is similar to U-shaped handle 106 and comprises two parallel and equal length straight cylindrical elongate supports, the first 203 and the second 204 supports (forming the legs of the U), which are attached roughly perpendicularly to the plate 202 at their first ends 215 and 216 respectively by some means such as fasteners, welding or adhesives such that it is relatively centered in the plate 202, and each support 203 and 204 is attached roughly perpendicularly at its second end to one of the two ends of a straight, elongate, cylindrical hand grip 205 to form a first elbow 208 and a second elbow 209 respectively. The hand grip 205 is roughly parallel to the pull plate 202.

The hand grip 205 is vertically aligned when the pull plate door opener 200 is mounted to a door in the typical orientation and the first support 203 on top. People grasp the hand grip 205 with one or more of their four fingers around one side and generally their thumb around the other, and then pull on the hand grip 205 to open the door. Pull plate door opener 200 is of the type often found on doors of public restrooms; often there is a push plate on the opposite side of the door for people to push on to open the door. In the embodiment in FIG. 2, the pull handle 201 is formed from a single elongate cylindrical rod that is bent at two points equidistant from its two ends 215 and 216 into right angles in the same plane and in the same direction to form the first 208 and second elbows 209 between the two ends of the hand grip 205 and the first 203 and second 204 supports respectively. The two supports 203 and 204 and the hand grip 205 can also be separate elements attached to each other by some means such as fasteners, adhesive or welding. In some embodiments, one of the upper first support 203 or the lower second support 204 is eliminated, and the pull is L-shaped with only one support being attached to the plate, either the top first 203 (to create a pull with the grip part 205 of the pull extending down from the support) or the bottom second support 204 (creating a pull with the grip part 205 of the pull extending upwards from the support), with the remaining support typically shorter in length than the grip 205; the DQ grip is attached proximal to and extending laterally from the remaining elbow.

Extending roughly orthogonally from the left side of the upper elbow 208 at roughly the point where the hand grip 205 and first support 203 meet is a DQ grip 207. The DQ grip 207 is oriented roughly horizontally when the pull plate 200 is mounted to a door with the hand grip 205 vertically oriented. First support 203 is preferably long enough (measured between the plate 202 and the upper elbow 208) that the DQ grip 207 is far enough from the pull plate 202 that a person can grasp the DQ grip 207 without his or her knuckles touching the plate 202; for public restroom pull plates this is typically at least 1.5 inches and often between 2 and 3.0 inches. In this embodiment, DQ grip 207 has lateral sides that slope out from a small rounded top 212 to a larger base 213 which is attached to the side of the elbow 208. To improve the purchase a pinky can obtain on the DQ grip 207, the pulling surface side 211 facing the door is slightly concave between the base 213 and the top 212 while remaining convex in its transverse cross section. A DQ grip of any appropriate form could be used instead. The grip 207 preferably measures between 0.375 and 0.75 inches from base 213 to top 212 (measured orthogonal to the upper support 203), and measures between about 3/16 and ¼ inch across at its top 212 and about 0.5 and 0.75 inches across at its base 213. In one embodiment, the DQ grip 207 is cylindrical with a rounded top, and measures between 0.375 and 0.625 inches in height and has a diameter of between about 0.25 and 0.5 inches. In one embodiment, the DQ grip 207 is hourglass shaped with a minimal cross-sectional diameter between about 0.25 and 0.5 inches and a maximum cross-sectional diameter between about 0.375 and 0.75 inches.

To use the DQ grip 207, a person will typically hold his or her right hand with its palm facing down, wrap his or her right pinky around the DQ grip 207, and then pull. The DQ grip 207 can also be grasped using the left pinky with the palm up. In general, a horizontal or non-vertical DQ grip will extend from the door opener in a direction away from the hinges of the door to which the door opener is attached so that the user can release his or her hand towards the door's outer edge without having to cross over the pull 201 in the process; thus the door opener 200 is preferably for a right-handed door (one with its hinges on the right edge). For a left-handed door, the DQ grip 207 would project out from the right side of the first elbow 208 (or the second elbow 209). In one embodiment, there is a second DQ grip projecting horizontally from the left side of the second elbow 209. In one embodiment, there is a second DQ grip projecting horizontally from the right side of the first elbow 208; in another embodiment, the second DQ grip is projecting vertically upwards from the top support 203 proximal to the first elbow 208.

In one embodiment, the pull plate door opener 200 is intended to be mounted to a door with crosspiece grip 205 vertically oriented but with the first support 203 below the second support 204 so that the formerly top first elbow 208 is now the bottom bend and the DQ grip 207 projects horizontally from the lower elbow. This embodiment puts the DQ grip within easy reach of children and shorter adults. In one variation of this embodiment, there is a second DQ grip which projects vertically upwards from the second support 204 (now the upper of the two support legs) proximal to the second elbow 209; this second DQ grip is equivalent to the DQ grip 104 in FIG. 1A. If the door opener 200 is installed with the first support 203 down, it would be preferably for a left-handed door because the DQ grip would be projecting out from the right side of the U-shaped handle 201.

Finger grips can be extended to other devices which rely for their operation on a force applied by a hand. Slide bolt latch 300 shown in FIG. 3 comprises a bolt 301 housed slideably in a bolt housing 302. Attached perpendicularly to the bolt 301 is a tab 304 that is used to slide the bolt 301. The tab 304 is attached to the bolt 301 through a rectangular slot 305 in the bolt housing 302, the long dimension of which is aligned with the direction of bolt movement 307. Attached to the top edge 306 (as oriented when mounted properly to a door) of the tab 304 at its distal end away from the bolt housing 302 is a DQ grip 303. Users can push the tab 304 as they would the tab of any similar slide bolt or they can grab the DQ grip 303 with their pinky and slide the bolt 301 into and out of the housing 302. The distance between the side of the DQ grip 303 closest to the surface to which the slide bolt 300 is attached and that surface is preferably at least one inch so that the DQ grip 303 can be operated without any other part of the hand touching that surface. Many existing slide bolt latches have a rod instead of a tab for moving the bolt, and in one embodiment, the tab 304 is replaced by a rod that projects from its first end perpendicularly out from the bolt 301 through the slot 305. At the second, free end of the rod is a DQ grip extending vertically upwards from the rod (when mounted). The rod can be a single rod that is bent at one end to form a DQ grip and which is attached at its other end to the bolt.

The DQ grip of the present invention is a grip intended to be grasped by wrapping the pinky at least partly around the DQ grip. The following drawing illustrates how a DQ grip interacts with the pinky and hand.

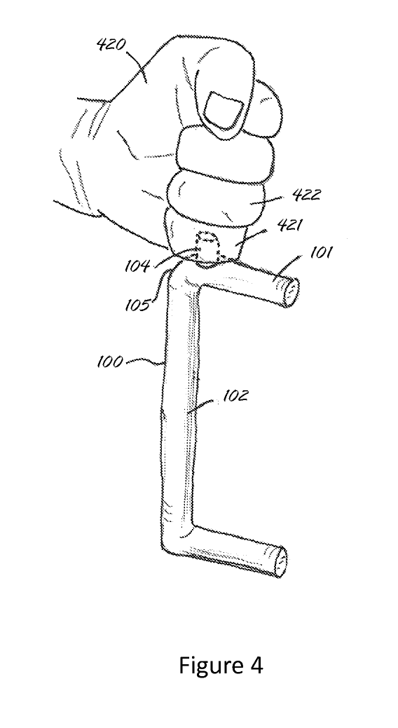

FIG. 4 shows the DQ grip 104 of the pull 100 shown in FIG. 1A being grasped by the left hand 420 of an average adult. The pinky 421 is wrapped around the DQ grip 104 (its location is indicated by dotted lines to show where it is relative to the pinky 421 and ring finger 422). The only part of the hand that is touching the DQ grip 104 is the surface of front side of the pinky (that part facing in the same direction as the palm when the hand is open and flat) and a small area of the palm proximal to the pinky's metacarpophalangeal joint. The DQ grip 104 is located on the top, first support 101 proximal to the first elbow 105 between the first support 101 and hand grip 102 so that the only part of the hand 420 touching the first support 101 is outer edge of the pinky (i.e., the side opposite the ring finger 422) and perhaps a small portion of the edge of the palm adjacent to the metacarpophalangeal joint; the rest of the hand is suspended or cantilevered over open space beyond the first elbow 105. The DQ grip 104 is shorter in height (between about 0.375 and 0.625 inches) than the pinky 421 is in width (measured across its inner or front side) so the pinky completely covers the lateral sides of the DQ grip 104 and keeps the ring finger 422 from touching the DQ grip 104. The DQ grip 104 is thin enough transversely (preferably between about 0.25 and 0.5 inches) that the pinky 421 effectively covers its top as well.

For some people, limiting contact to just those areas of the pinky in contact with a DQ grip is still not enough. These individuals wish to prevent all contact between their skin and any part of the door and door opener. Because of its small size, a DQ grip makes it easy to eliminate all contact. Currently, many people use a hand towel to protect their hand from contact with the hand grip of a prior art door pull, and some public rest rooms even provide dispensers for paper hand protectors. However, because the contact area between the hand and pull is generally quite extensive (i.e., the entire hand is generally used to grasp the grip), the paper protector must be positioned just right or else some part of the hand will touch the hand grip. Also, the paper protector must be relatively large to be able to protect the entire hand. Using the same paper towel or protector with a DQ grip requires only that the paper come between a portion of the outer edge of the hand (the outer edge includes the edge of the pinky opposite from the ring finger and the edge of the palm opposite the thumb) and the support for the DQ grip, and between the DQ grip and the pinky.

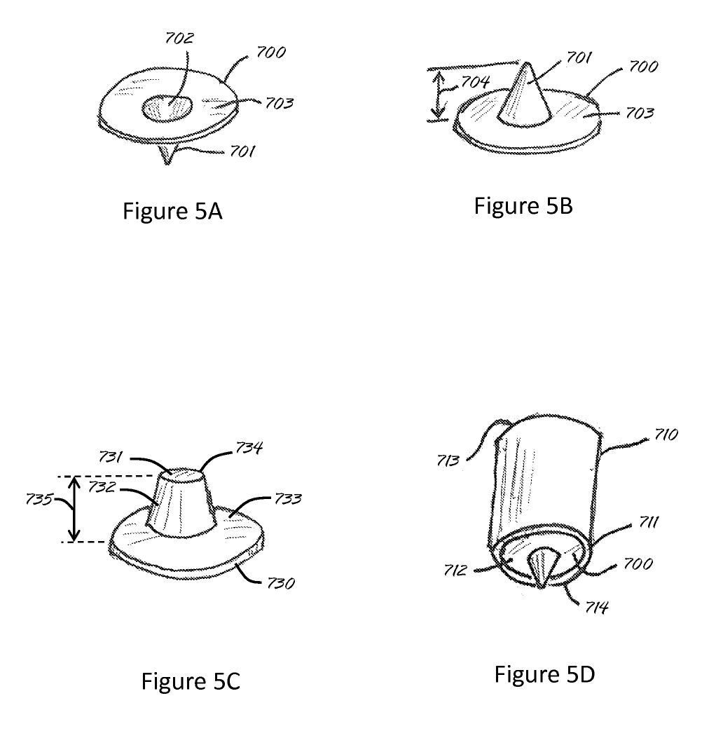

Moreover, the design of DQ grips makes possible a novel compact disposable hand protector that can be used to prevent all contact between the person using a DQ grip to open a door and the DQ grip itself, one embodiment of which is shown in FIGS. 5A and 5B, and another embodiment of which is shown in FIG. 5C. In form similar to a miniature witch's hat, the hand protector 700 comprises a hollow conical cover 701 which forms a cavity 702 into which a DQ grip will fit, and a wide rim or flange 703 proximal to the open end of the cover 701 and projecting outwards therefrom at an angle roughly perpendicular to the axis of the conical cover.

The protector 700 is designed to be placed over a DQ grip, and the dimensions of the protector 700 will be determined in part by the DQ grips with which it is expected to be used. The cover 701 is of sufficient size to fit over the DQ grip and prevents the user's pinky from coming into contact with the DQ grip. The flange 703 prevents the outer edge of the user's hand from contacting the supporting structure to which the DQ grip is mounted (e.g., a pull, a knob, a lever). A person holds the protector 700 by grasping the cover 701 by wrapping his pinky around the base of the cover 701 adjacent to the rim 703, places the cover 701 over a DQ grip, and then pulls on the DQ grip through the protector 700.

In one embodiment, the wall of DQ grip cover part is cylindrical so that the protector resembles a miniature stove pipe hat. In one embodiment shown in FIG. 5C, pointed top of the conical cover 701 is cut off and replaced with a flat top 731. The protector in this embodiment resembles a miniature pilgrim's hat. In this embodiment, the protector 730 comprises a cover 734 comprising a top 731 parallel to the rim 733, with outwardly sloping sides (the diameter of the opening of the cavity [not shown] is larger than the diameter of the top 731); the cover 734 resembles a miniature stackable drink cup with sloping sides between an open end and a flat bottom. In either of these embodiments, the height 704 of the cover 701 or the cover 731 (measured to the rim 733) can be the same or slightly higher than the height of the DQ grip. In one embodiment, the DQ grip cover part has two open ends, with sloping walls between (a portion of the closed tip of the conical DQ grip cover is removed). There is no need for a top if the cover is higher than the DQ grip. If the sides of the DQ grip cover part of the protector are sloped, like those of most disposable drinking cups, the protectors can be nested for stacking in the same way as disposble drinking cups. However, although a cavity with sloped sides like those used for paper cups lends itself to stacking, the cavity 702 can have any shape that will fit over the DQ grip with which it is intended to be used and keep the hand from contacting the DQ grip and its support. The protectors are preferably symmetrical so they can be used in any orientation around the axis of symmetry.

The protectors can be made out of any appropriate material, and can be disposable or durable. Disposable hand protectors can be made out of any of the material strong enough to resist perforation in use, such as those used to make disposable cups, including plastics and paper, except that the materials used do not need to be water impermeable, although resistance to water is desirable. Durable protectors can be made out of stronger materials such as hard plastics, composites, ceramics or metals. The covers 701 and 734 and the rims 703 and 733 can be made out of the same or different materials.

The height 704 of the DQ grip cover part 701 and the height 735 of the cover 734 (this will correspond to the depth of the cavity within the cover, provided the materials of which both the rim and cover part are made have equal thicknesses) is at least as high as the DQ grip over which it is to be placed, and greater if the DQ grip is not itself conical; the intent is for the cover part to completely cover the entire DQ grip, coming between the finger wrapping around the DQ grip and the DQ grip itself. In an embodiment with a flat or no top, the DQ grip cover part is preferably slightly higher than the DQ grip; for example, 0.4″ and 0.8″ for DQ grips 0.375″ and 0.75″ high respectively (for a two-fingered grip, the cover part may have a deeper cavity). The cavity formed by the cover part should have cross-sectional dimensions (measured across the cavity parallel to the rim) larger at all points than the corresponding cross section of the DQ grip (for example, at least 0.375″ across at the top of a 0.375″ wide DQ grip). The rim 703 is preferably wide enough (measured from the bottom edge of the DQ grip cover part to the outer edge of the rim) to prevent contact between the hand and the support to which the DQ grip is attached; it is at least a pinky width (measured front to back) wide. For an adult hand, a rim measuring about ¾ inch to one inch is sufficient, although one as wide as 1″ or 1.25″ will provide a greater margin of protection, provided the DQ grip is situated on the support close to an edge so the heel of the edge of the hand extends beyond the support, as in FIG. 4. Otherwise, a wider rim would be needed to keep the hand from touching the support.

FIG. 5D shows a dispenser 710 for the protector 700 that operates like a paper cup dispenser. The dispenser is meant to be installed so that it is vertical with the top end 713 up. A stack of protectors is inserted into the top 713 end of the dispenser 710. The inner diameter of the dispenser 710 is greater than the diameter of the protector's rim 703 so that the stack of protectors will be pulled by gravity to the bottom of the dispenser. Around the bottom end 714 of the dispenser 710 is an inward-pointing lip 711 which reduces the inner diameter of the opening 712 at the bottom end of the dispenser 710 enough that it catches the rim 703 of the protector 700 and prevents it from falling through. It works in the same way as a cup dispenser. A user grasps the protector that is exposed, and pulls it out of the dispenser. In one embodiment, the dispenser 710 incorporates a spring-loaded plunger which pushes the protectors 700 into the lip 711; this dispenser can be oriented with the top end 713 down so that the DQ grip cover part 701 of the top protector 700 is protruding from the top of the dispenser and can easily be picked up in the same orientation as they will be used. It is well known how to construct paper cup dispensers, both those that dispense cups from the bottom and those that dispense cups from the top, and that knowledge can be used to construct a dispenser for the DQ grip protectors described above.

A stack of disposable DQ grip covers can be placed over a DQ grip and secured so that each user removes the top DQ grip cover after opening the door. In this case, the DQ grip covers may be made out of a very thin material, such as tissue paper.

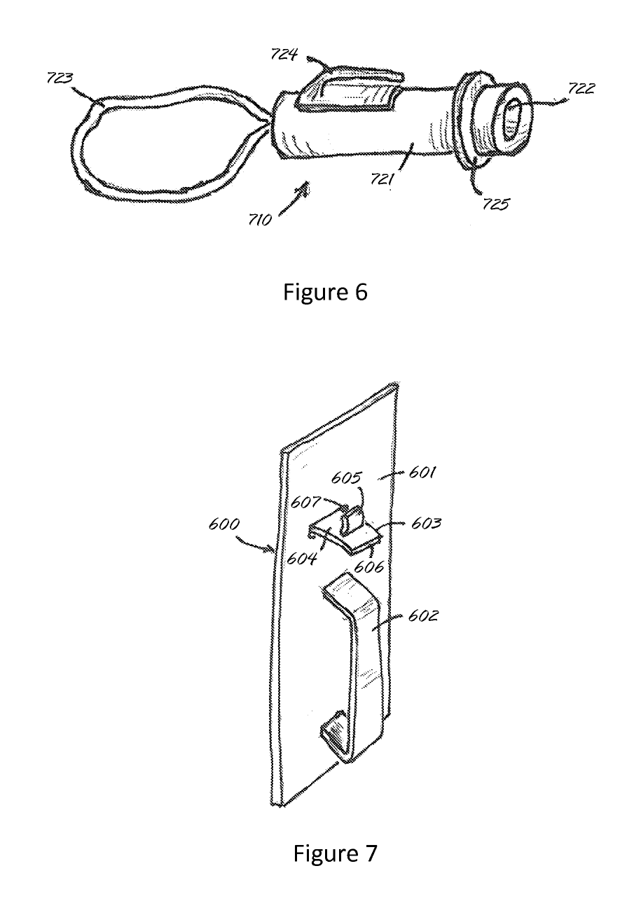

In some environments, such as a hospital, people may be frequently opening doors using DQ grips because they need to avoid all skin contact with doors and door handles. FIG. 6 is a perspective drawing of a device for opening doors having a DQ grip as a door opener. A grip operator 720 comprises a cylindrical handle 721 having a cavity 722 at one end large enough to accommodate the DQ grip for which it is going to be used, a flange 725 at or near the end having the cavity 722, an optional clip 724 for clipping the grip operator 720 to a belt, shirt pocket or other appropriate spot, and an optional lanyard 723 at the end opposite the cavity 722 for securing the grip operator to a wrist or elsewhere. To use, a person holds the grip operator 720 in his fist with his pinky above the flange 725 (on the side of the flange 725 away from the cavity end; the flange keeps the pinky from touching the support to which the DQ grip is attached), places the cavity 722 over the DQ grip, pushes down slightly, and pulls on the grip operator.

DQ grips can be incorporated into other types of door handles and openers besides pulls. Handlesets are door latch sets that when mounted on a door incorporate on one side of the door a pull and a thumb tab for releasing the latch, and on the opposite side of the door a push bar, door knob or lever, also for releasing the latch. A latch mechanism is generally recessed into the edge of the door between the two latch releases. Handlesets optionally include a lock set extending through the door which allows a user to lock the door. The handleset 600, of which only one side is shown in FIG. 7, incorporates a DQ grip. The handleset 600 comprises a mounting plate 601 for mounting the handleset 600 to a door, a U-shaped pull 602 attached to the mounting plate 601, and a latch release 603 extending through a slot 607 in the plate 601 for releasing a latch (not shown) above the U-shaped pull 602 (when mounted). The latch release 603 comprises a thumb tab 604 attached at one end to the latch mechanism (not shown) and to which a DQ grip 605 is attached roughly perpendicularly. The DQ grip 605 is mounted back from the free end 606 of the latch release 603 to provide room for a person's thumb to press down on the free end 606 of the latch release 603, but far enough from the mounting plate 601 so that a finger can preferably grasp the DQ grip 605 without any part of the hand touching the mounting plate 601. To open the door to which the handleset 600 is mounted using the DQ grip 605, a person grasps the DQ grip 605 with his pinky, pushes down on the thumb tab 604 to release the door latch, and then pulls on the DQ grip 605. The DQ grip 605 in this embodiment is a thin rectangular tab mounted with its wide side roughly parallel to the mounting plate, but it could have any other appropriate form. The DQ grip 605 is roughly planar horizontally and curved vertically, with the concave side facing the mounting plate.

DQ grips can be incorporated into other types of door opening devices, such as lock sets with lever or knobs for handles. The door opener 900 in FIG. 8 comprises a lever-type (lever-handle) door opener 910 having a DQ grip 902 attached to and extending upwards at roughly a ninety degree angle from the lever handle 901 proximal to its free end 903 (the lever handle 901 will be roughly horizontal when the door opener 900 is mounted to a door). The lever-type door opener 910 comprises a lever handle 901 attached at a first end to a handle base 907 within which is disposed a locking mechanism 911 and a spindle (not shown) which passes through the door to engage with the latching mechanism (not shown) and a door lever or knob on the other side of the door. To open the door, a person can grasp the lever handle 901 with the full hand as is normally done (four fingers over the top, thumb wrapping around the bottom), or can grasp the DQ grip 902 with his pinky; next the person pushes the lever down to unlatch the door, and then pulls on the lever handle 901 itself or on the DQ grip 902.

In some doorways, the strike plate in the door frame is electrically controlled so that, for example, it is always open during business hours and the door can be opened without turning the door handle; a person simply pushes on the door or pulls on the handle, and the strike plate releases to let the latch pass by. The door opener 920 shown in FIG. 9 is designed for such a doorway, and comprises a lever-type door opener 910 having a cylindrical DQ grip 912 attached to the handle base 907. The longitudinal axis of the DQ grip 912 will be roughly parallel to the surface of the door to which the door opener 920 will be attached so that its pulling surface will be roughly orthogonal to the direction of force to open the door (hinged doors generally have vertically aligned hinges, and the DQ grip and door will swing through a horizontal plane, so the force will generally be in the horizontal plane and more or less perpendicular to the door's surface, and tangential, at the DQ grip, to the arc through which the DQ grip moves as the door opens). The DQ grip 912 projects outwards from the handle base 907 at a roughly 45 degree angle up from the horizontal from the side of the handle base 907 opposite the lever (and opposite the hinges of the door), and is preferably attached to the handle base 907 as far away from the door and cover plate 908 as possible to minimize contact between the user's hand and the door and elements of the lever-type door opener 910. In one embodiment, the lever handle 901 of the door opener 920 is stationary and there is no latching mechanism to release; a user simply pulls on the handle 901, or on the DQ grip 912, to pull open the door to which the door opener 920 is attached.

FIG. 10 shows a door opener 1000 comprising a knob-type door opener 1006 and a DQ grip 1002. The knob-type door opener 1006 is of the type found in many homes and comprises a tulip-shaped knob 1001, attached at a first end to a thinner neck 1004, within which is disposed a shaft (not shown) that engages the door opener's 1000 latching mechanism (only the key part 1007 is shown) and typically a knob on the opposite side of the door, with the neck 1004 rotatably passing through a mounting plate 1005 by which the knob-type door opener 1006 is mounted to a door. Door knobs typically have a substantially circular cross-section perpendicular to the axis around which the knob is turned to release the latch. The DQ grip 1002 is attached to upper, curved side of the knob (when mounted to a door) proximal its second, free end 1003, and projects out normal to its curved surface. To open a door on which the door opener 1000 is mounted, a person either grasps the knob 1001 with his thumb and first two or three fingers (starting from the forefinger), turns it and then pulls, or grasps the DQ grip 1002 with his pinky, uses the DQ grip 1002 to turn the knob 100, and then pulls on the DQ grip 1002. In one embodiment, the knob 1001 of the door opener does not turn and there is no latching mechanism to release (closet doors often have door openers such as this). In this embodiment to open the door to which the door opener 1000 is attached, a user simply grasps the knob 1001 with his hand and pulls on it, or grasps the DQ grip 1002 with his pinky and pulls on it. In this embodiment, the knob 1001 is the first handle or grip and the DQ grip 1002 is the second handle or grip.

Some hinged doors close automatically after being opened (typically by a spring mechanism or a motor), and with these doors a DQ grip will generally only be used to pull open the door. Some hinged doors do not close automatically, but must be pushed closed. In this case, a DQ grip may be used to both pull open and push closed a door. Moreover, latchable hinged doors have a door opener on both sides of the door. The door opener on one side of the door is used to release the latch and pull open the door (the pull-side door opener), while on the other side of the door the door opener is used to release the latch and push open the door (the push-side door opener). A DQ grip can be incorporated into either of those door openers. For example, the lever-type door openers 900 and 920, and the knob-type door opener 1000 can be used on either the push-to-open side or the pull-to-open side of a door. The pulling surface of a DQ grip used on the pull side of a hinged door and the pushing surface of a DQ grip used on the push side of the hinged door should be comfortable to use for both pulling and pushing. A cylindrical DQ grip of sufficient height (between about ⅜ and ¾ inch) and diameter (between about ¼ and ½ inch) will be comfortable to both push and pull on to open and close a door, and to push and pull on from various angles (people will not always pull or push in exactly the same direction on the DQ grip).

DQ grips can also be used to apply a sideways force to an object, such as a sliding door, which instead of opening away from a door frame and pivoting around its hinges as hinged doors do, opens by sliding along a track parallel to the door. Sliding door opener 1100 in FIG. 11 comprises a curved handle 1101 with a roughly rectangular cross section having a cylindrical first DQ grip 1102 projecting outwards from its convex side (away from the door) roughly normal to its curve proximal to the handle's 1101 upper end 1104 (when mounted with the handle 1101 vertically oriented) and a cylindrical second DQ grip 1103 projecting outwards from its convex side roughly normal to its curve proximal to the midpoint of the handle 1101. The longitudinal axis of the first DQ grip 1102 is at an acute angle up from the horizontal plane and the longitudinal axis of the second DQ grip 1103 is roughly horizontal. The curved handle 1101 is of the type commonly used on the sliding doors for refrigeration cases in supermarkets or residential glass sliding doors. Like those handles, the handle 1101 is attached to a door at two points, at a first 1104 and a second 1105 end. A person can use either DQ grip 1102 or 1103 to open the door to which the sliding door handle 1100 is attached by grasping the DQ grip and pulling the door in the direction he wants the door to slide, or the person can grasp the handle 1101, curling his non-thumb fingers around it from either side (palm facing the door or facing away from the door) and perhaps curling his thumb around it from the other side. Since the DQ grips 1102 and 1103 can be used for applying either a pushing or a pulling force to the door in either direction, the DQ grips should be designed to be comfortable for both pushing or pulling from or against both sides. In one embodiment, the sliding door opener 1100 incorporates only the first DQ grip 1102. In one embodiment, the sliding door opener 1100 incorporates only the second DQ grip 1103. A DQ grip can be attached to the curved handle 1101 anywhere along its length; preferably it is not angled so far down from the horizontal that it is uncomfortable to grasp with the pinky or so close to the door that a person using it will inevitably touch the door. Sliding door handles come in many styles, and a DQ grip can be incorporated into almost any of them. These include sliding door handles comprising a handle that is supported by and mounted to the door by two support legs.

The sliding door handle 1120 comprises the sliding door opener 1100 and two cylindrical, elongate, parallel, equal-length supports, first support 1121 and second support 1122, that are adapted at their first free ends 1123 and 1124 for attaching to a sliding door and are attached to the backside of the handle 1101 at their other ends. In one embodiment, the handle 1101 is straight, the longitudinal axis of the first DQ grip 1102 is aligned to the longitudinal axis of the first support 1121, and the second DQ grip 1103 is eliminated.

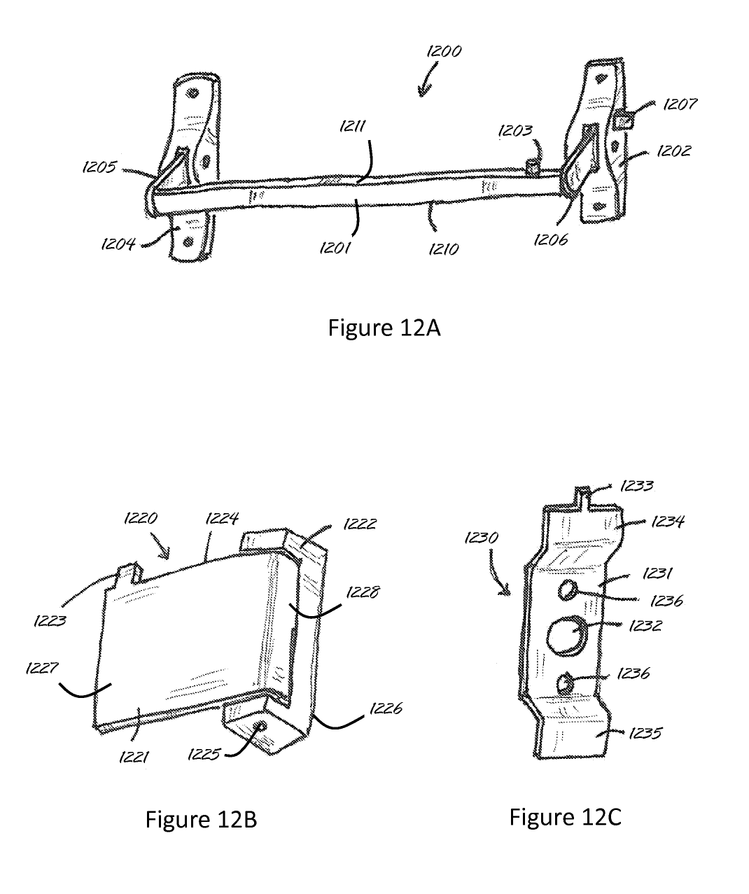

As stated above, DQ grips can also be used to apply a pushing force. Crash bars are installed on the push-side of hinged doors that close automatically. Crash bar style push bar door opener 1200 in FIG. 12 comprises a crash bar door opener 1210 of the type found on many commercial exit doors and a DQ grip 1203. The crash bar door opener 1210 comprises an elongated push bar 1201 which is attached at a right angle at each of its two ends to two parallel supports, the left first 1205 and right second 1206 supports, which are pivotably attached to the first 1204 and second 1202 door mount assemblies respectively, one of which, the first mount 1202, encloses the latching mechanism of the door. The DQ grip 1203 is attached to the top side 1211 of the push bar 1201 and extends vertically upwards from it when the crash bar style push bar door opener 1200 is properly mounted to a door. A person can open the door by grasping the DQ grip 1203 with his pinky and pushing forward on the DQ grip 1203 until the door latch 1207 is released, or by pushing on the push bar 1201 to release the door latch 1207. The DQ grip 1203 can be situated anywhere along the length of the bar 1201, but is preferably situated as close to the latching assembly (and as far away from the hinges of the door) as possible in order to minimize the force necessary to push open the door. In one embodiment, crash bar style push bar door opener is a touch bar style push bar door opener. In one embodiment, the two parallel supports 1205 and 1206 are fixedly attached to the first 1204 and second 1202 door mount assemblies respectively, and there is no latching mechanism enclosed within the second door mount assembly 1202. In one embodiment, the parallel supports 1205 and 1206 are attached directly to the door and there are no door mount assemblies.

The door opener 1220 in FIG. 12B comprises a push-pull paddle door opener 1226 and a DQ grip 1223. The push-pull paddle door opener 1226 comprises push-pull paddle 1221 which functions as a handle and is hingeably attached to a base 1222 which is mounted, when in operation, to a door such that the hinge 1225 (only the end of the hinge pin 1225 is visible) of the paddle 1221 is vertically oriented. The DQ grip 1223 is attached to the upper edge 1224 of the paddle 1221 at some distance from the paddle's hinge's pivot point 1225 for increased leverage. It 1223 extends vertically upwards from the upper edge 1224. The push-pull paddle 1221 is roughly parallel to the surface of the door when mounted. The push-pull paddle 1221 comprises a large, rectangular planar paddle 1227 attached along one edge at a roughly right angle to a second element 1228 which is pivotably attached to the base 1222 and which operates the latch mechanism. By grasping the DQ grip 1223, or the push-pull paddle 1221, and pushing or pulling, the door to which the door opener 1220 is attached can be opened.

The pull trim door opener 1230 in FIG. 12C comprises a pull plate 1201 comprising an upper pull handle or hand grip 1234 and a lower pull 1235 (when mounted on a door), an optional opening 1232 sized to fit over and around a rim lock cylinder so that the key hole of the lock is accessible, and a DQ grip 1233 extending vertically upwards from the free edge of the upper pull 1234 (in another embodiment, the DQ grip extends horizontally from the side of either the upper pull 1234 or the lower pull 1235). A person can use the DQ grip 1233 to pull open or push open or close the door to which the pull trim 1230 is mounted. The DQ grip 1233 can be an integral part of the pull trip 1230 or can be a separate element that has been attached to the pull plate 1201. In this embodiment, the DQ grip 1233 is a rectangular tab, preferably with rounded edges, but the DQ grip 1233 can be cylindrical or one of the other forms discussed herein or consistent with the design principles outlined elsewhere.

There are many types of existing door openers into which a DQ grip can be incorporated or to which a DQ grip can be attached. These include openers that are passive or fixed (they do not move when used) and are simply used to push or pull open a door to which they are attached. These also include active door openers that control the movement of a door latch by pushing or pulling.

A new type of door opener, the finger-grip door opener 800 shown in FIG. 13A, can be designed. The finger-grip door opener does not have a handle for grasping with the full hand; the only handles for unlatching and opening a door on which it is installed are two DQ grips (FIG. 13C shows the new door opener 800 installed on a door 842). The finger-grip door opener 800 comprises a slidable shaft 801 that can be moved to release the latch of a door lock, such as a mortise lock or bored cylindrical lock (with or without a locking mechanism). Mortise and bored cylindrical locks typically have a non-circular orifice for accepting a shaft attached to a rotatable handle (e.g., knob or lever) so that when the handle is rotated appropriately, the latch or bolt is moved. Removably attached at the pull end of the shaft 801 (the end of the shaft 801 towards which the shaft 801 moves [is pulled] to move the latch) is a pull-side DQ grip 802 and at the push end of the shaft 801 (the end of the shaft 801 away from which the shaft 801 moves [is pushed] to move the latch) is a push-side DQ grip 803; both are cylindrical, although DQ grips in other shapes can be used (for example, the push-side DQ grip 803 can be shaped to have a flatter surface against which to push).

A latch-interface assembly 810 comprises a square shaft 811 designed to fit into a square opening in the latch mechanism (not shown; other latches have differently shaped openings, and the square shaft 811 can be replaced by a shaft of suitable cross-sectional shape to fit into that differently shaped opening) and a circular flange 812 having a grooved outer edge 813. The latch-interface assembly 810 has a cylindrical hole 815 passing through the center of the square shaft 811 and the circular flange 812 within which a portion of the slidable shaft 801 is movably disposed; the hole 815 is large enough that the slidable shaft 801 and latch-interface assembly can move freely relative to one another, with the shaft 801 able to slide back and forth and the assembly 810 able to rotate around the slidable shaft 801 with minimal resistance, but not so large as to allow significant side-to-side movement of the slidable shaft 801.

The square shaft 811 fits into a square opening in the latch mechanism of the lock. Rotating the square shaft 811 causes the square opening to rotate as well which moves the latch, typically retracting it into the door (in a typical door latch or lockset incorporating a door knob, turning the knob rotates a square shaft passing through a square opening in the lock to the same effect). The latch-interface assembly 810 is held in the square opening in the latch mechanism by a pair of plates 820 and 823 which bolt together on either side of the latch-interface assembly 810 and latch mechanism. The first plate 823 has a pair of holes 825 aligned with a pair of threaded holes 825 in the second plate 820. The plates are larger than and overlap a opening drilled through the door (typically this is about 2.25 inches in diameter and is drilled perpendicular to the travel of the latch bolt between the front and back of the door) so bolts tightened through the holes 825 into the threaded holes 824 will pull the first 823 and second plates 820 tight against the front and back of the door, thereby clamping the door opener 800 in place. A bushing 821 disposed between the second plate 820 and the grooved flange 812 prevents the latch-interface assembly 810 from backing out of the square opening in the latch mechanism (the bushing can be replaced by a spring or other type of spacer). The bushing 821 has a hole in its center through which the slidable shaft 801 passes freely, as do the two plates 820 and 823.

A length of a cable 814 is disposed in the grooved edge 813 and a first end 848 is anchored therein. The cable 814 is threaded into the orifice 826 of and through a guide tube 827 mounted to the second plate 820, and out a hole 828 (shown in FIG. 13B) in the second plate 820 aligned with the guide tube 827. The orifice 826 is roughly aligned with the grooved edge 813 so that a force exerted by pulling the cable 814 from the end exiting the hole 828 in the second plate 820 will be tangential to the circular flange 812. FIG. 13B is a detail of the side of the second plate 820 not visible in FIG. 13A and shows that part of the path of the cable 814 that cannot be seen in FIG. 13A. After exiting the hole 828, the cable 814 passes through a guide eye 829 attached to the back side of the second plate 820. After passing through the guide eye 829, the cable 814 is roughly parallel to the sliding shaft 801, to which it is anchored, preferably disposed within a groove 830 so that the cable 814 is flush with the shaft 801.

To pull open a door to which the DQ grip door opener 800 is mounted, one grasps the pull-side DQ grip 802 with one's pinky and pulls. Pulling on the pull-side DQ grip 802 pulls the cable 814 through the guide eye 829, the hole 828 and the guide tube 827, which exerts an upward force on the outer edge of the circular flange 812 (the groove 813 keeps the cable 814 from slipping off the flange 812), causing the flange 812 and the latch-interface assembly 810 of which it is a part (including the square shaft 811 which is seated in a square, rotatable opening in the latch mechanism) to rotate upwards towards the guide tube 827 (clockwise when viewed as in FIG. 13A). This rotation retracts the latch of the latch mechanism. Because the push-side DQ grip 803 is attached to the same slidable shaft 801 as the pull-side DQ grip 802, grasping the push-side DQ grip 803 with the pinky and pushing has the same effect of moving the latch. The cable 814 can be attached to the circular flange 812 so that it 812 will rotate counterclockwise or clockwise when the cable 814 is pulled, whichever is suitable for opening the latch mechanism.

A first 832 and second 831 decorative cover can be installed over the two plates 820 and 823 respectively on either side of the door. The covers 832 and 831 each have a hole in their center (835 and 834 respectively) through which the slidable shaft 801 can freely pass. The holes 834 and 835 in the decorative covers 831 and 832 respectively and the holes 837 and 836 in the plates 820 and 823 respectively are all aligned, and are big enough that the slidable shaft 801 can slide back and forth with minimal resistance, but small enough to minimize its lateral movement. The decorative covers 831 and 832 are formed to have recesses into which the plates 823 and 823 can fit and be completely covered. The first decorative cover 832 has two threaded bosses and the second decorative cover 831 has two holes, and screws can be passed through the two holes in the second cover 831, and through aligned holes in the two plates 820 and 823, and be screwed into the threaded bosses to hold the decorative covers in place.

To prevent the sliding shaft from being pulled or pushed too far, an optional hard stop 844 is located between the push-side DQ grip 803 and the decorative cover 831; the stop 844 is too big to pass through the hole 834 in the cover 831. The stop 844 must allow the push-side DQ grip 803 to slide far enough towards the door that the latch will be released. The stop 844 can be removable and adjustable. The DQ grips 802 and 803 are removable for ease of installation. To prevent the slidable shaft 801 from rotating it has a longitudinal spline 843 on at least that part of the slidable shaft 801 that is on the pull side of the second plate 820, with the spline 843 fitting into a keyway 842 in hole 835 in the decorative cover 832. There is a longitudinal spline 845 on the push end of the sliding shaft 801 which fits into a keyway 847 in the hole 834 in the decorative cover 831 and into a keyway 846 in the hole 836 in the first plate 823. Since the latch interface assembly 810 must be able to rotate around the slidable shaft 801, that portion of the slidable shaft 801 which is disposed within the assembly 810 when at rest and that which is pulled or pushed into the assembly 810 when the door is being opened should be round. There must be sufficient distance from the spline 845 on the push side to the square shaft 811 to allow the shaft 801 to slide a sufficient distance that the latch-interface assembly 810 will be rotated enough to release the latch.

The point 848 at which the cable 814 is anchored to the flange 812 must provide for sufficient length of free cable 814 between the guide tube 827 and the anchor point 848 to allow the flange 812 to be rotated sufficiently to release the latch when the slidable shaft is slid towards the pull-side DQ grip to the maximum extent; the cable can wrap all the way around the flange or partly; preferably it wraps at least ¾ of the way around the flange. The cable 814 must also be wrapped around the flange so that pulling on it turns the square shaft 811 in the correct direction.

The latches of most door locks are spring loaded so that they return to an extended, locked position absent an externally applied force. If the spring of the latch is insufficient to return the sliding shaft and DQ grips to the retracted, at rest position with the latch extended, a spring mechanism to return the sliding shaft 801 to the rest position can be added (rest position is with the latch extended).

FIG. 13C shows the door opener 800 installed on a door 842 with a bored cylinder lock mounted into the edge 843 of the door. The slidable shaft 801 preferably extends beyond the decorative cover 832 sufficiently that there is enough space around pull-side DQ grip 802 for a person to grasp it 802 without touching the door 842 or the decorative cover 832, and the push-side DQ grip 803 should preferably be far enough from the decorative cover 831 that it can be operated without touching the decorative cover 831 or the door 842.

Other designs for a DQ grip-type door opener are possible. In one embodiment, the hole in the latch mechanism interface assembly has a helical keyway that interfaces with a ‘key’ (such as a tab or boss) on the slidable shaft such that when the slidable shaft is moved, the key interfaces with the helical keyway to rotate the interface assembly enough to release the latch. Since most bored cylinder and mortise locks require about a fifth to a quarter turn or the handle or knob to release latch, the helical keyway should travel about a quarter of the way around the hole in the latch mechanism interface assembly.

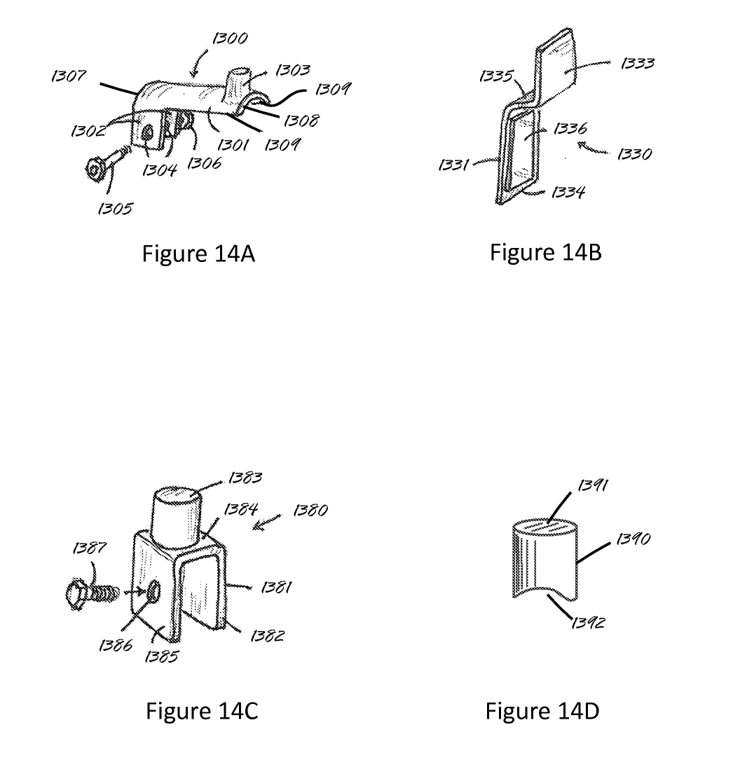

There is already a large installed base of prior art door opening devices (those not incorporating DQ grips). FIGS. 14A-14C show several types of DQ grip assemblies that can be used to retrofit existing door openers to add a DQ grip. DQ grip retrofit assembly 1300 in FIG. 14A comprises a partial-cylinder base 1301 (a portion of the curved wall of a hollow cylinder); a cylindrical DQ grip 1303 attached proximal to a first end 1308 of the base 1301 and extending roughly normal to the middle of the convex side of base 1301; two parallel tabs 1302 attached at the second end 1307 of base 1301 and extending from the lateral edges 1309 of base 1301, the tabs 1302 having aligned holes 1304; a bolt 1305; and a nut 1306 for the bolt. Assembly 1300 can be used to add a DQ grip to an existing pull. To do so, assembly 1300 is placed on top of the upper cylindrical support of the pull (such as support 101 of U-shaped pull 106) with the DQ grip 1303 roughly vertical and proximal to the elbow or bend between the upper support and hand grip, and with the tabs 1302 closer to the door to which the pull is mounted, and then pushing the bolt 1305 through the holes 1304, and threading on and tightening the nut 1306. When the bolt 1305 and nut 1306 are tightened, the tabs 1302 will clamp the assembly 1300 to the pull support. Assembly 1300 can optionally comprise an adhesive material on the concave side of the base 1301. Other clamping means can replace the tabs and bolt, such as a pipe-type clamp with flexible tabs for attaching around the pull or spring-loaded arms which push towards each other to grip the pull. The inner curvature of the base 1301 preferably is a close, but not any smaller, match to the curvature of the support on which it sits (if the support to which it is to be attached is rectangular, then the side of the base opposite the DQ grip will have a rectangular recess. A pull with DQ grip assembly 1300 attached will closely resemble door opener 100. In one embodiment, the base 1301 is flat; this embodiment can be used to add a DQ grip to a door handle such as the lever handle 900 in FIG. 9.

The DQ grip assembly 1330 in FIG. 14B can be secured to door openers using adhesive. Assembly 1330 comprises an L-shaped base 1331 consisting of two rectangular planar elements, a first long element 1334 and second short element 1335 joined at a right angle, each along one edge; a tab-like planar DQ grip 1333 attached to and extending perpendicularly up from (the first planar element 1334 extends down from the other end of the second planar element 1335) the free end of the second planar element 1335 (an optional layer of adhesive is on the underside of planar element 1335); and a layer of adhesive 1336 on the same side of planar element 1334 as element 1335. Assembly 1330 can be used to retrofit lever handles such as that shown in FIG. 9 by using the adhesive to affix the planar element 1334 to a relatively flat part of preferably the back side of the lever (the side facing the door) with the planar element 1335 extending over the top edge 905 or the side of the lever and the DQ grip 1333 extending vertically upwards from the handle. In one embodiment, first element 1334 is eliminated, and second element 1335 is made larger, and the adhesive layer is on the side of element 1335 opposite the DQ grip 1333. In one embodiment, the DQ grip 1333 is cylindrical and is attached to the top side of second element 1335. The DQ grip assembly 1330 can also be attached to a door opener using a fastener or by welding or by some other means.

The DQ grip assembly 1380 in FIG. 14C is designed to clip onto a door handle lever. The assembly 1380 comprises a U-shaped clip 1381 (for example, a planar rectangular strip of metal bent lengthwise into right angles at two places to form a U) with two equal length parallel rectangular legs, first planar leg 1382 and second planar leg 1385, connected by a rectangular planar base 1384, with both legs attached at right angles to opposite edges of the base 1384 and extending in the same direction from the bottom side of the base 1384. The two legs 1382 and 1385 are spaced sufficiently to admit a door handle lever. The second leg 1385 has a threaded hole 1386 near its center. A cylindrical DQ grip 1383 is attached to top side of the base 1384 at a roughly perpendicular angle. To attach the DQ grip assembly 1380 to a door handle lever such as lever 901 (see FIG. 9), the clip 1381 is slipped over the top 905 of the lever 901 so that the first leg 1382 against the front side 909 of the lever and the second leg 1385 is behind the lever 901. A bolt 1387 is screwed into the threaded hole 1386 and tightened into the back side of the lever until the DQ grip assembly 1380 is securely clamped to the lever.

FIG. 14D shows a cylindrical DQ grip 1490 for converting a prior art pull such as the pull 106 in FIG. 1, pull 181 in FIG. 1D or U-shaped pull 201 in FIG. 2 into a door opener which incorporates a DQ grip. Many current pulls are made from a single unitary cylindrical rod of a metal such as steel, stainless steel, brass or aluminum which is bent to form supports and a handle, with elbows in between them. The supports are adapted in some way for attaching the pull to a door, such as by welding the free ends of the supports to a mounting plate (or each to its own mounting plate) or making a threaded hole in their free ends. The DQ grip 1490 is a length of cylindrical rod having a top end 1491, and a second end in which a concave cylindrical notch 1492 is formed. The inner radius of the notch 1492 is the same as the radius of the cylindrical rod from which the pull is made. To convert a prior art pull, such as pull 106 in FIG. 1, to a pull of the present invention using the DQ grip 1490, one places the DQ grip 1490 on a straight section of the pull, such as to the upper support 101 proximal to the elbow 105 between the support 101 and the handle 102, such that it projects outwards from the pull at a desired angle, and then securely affixes the DQ grip 1490 to the pull, such as by welding, and adhesive or a fastener.

A novel method for making a pull is disclosed comprising the steps of: (a) forming a pull by cutting a first rod having a first diameter to a desired length; bending the first rod in two or more places to form a pull (if the pull has only one support, then the rod may be bent in only one place to form the pull; also the radius of the bend can vary as it does in prior art pulls); and adapting the free ends of the rod for mounting to a surface, such as by forming threaded longitudinally aligned holes in them or attaching them to mounting plates (or to a mounting plate); (b) forming a DQ grip component by cutting off a section of a second rod having a second diameter of between about 0.25 and 0.625 inches (or having one of the other diameters or ranges of diameters for DQ grips described elsewhere herein) to a desired length of between about 0.375 and 1 inches (or to one of the other lengths or ranges of lengths for DQ grips described elsewhere herein); and forming a notch in a first end of the cut-off section of the second rod, the inner form of which conforms to a first section of the pull (for example, if the first rod is cylindrical and has a radius of X, and the DQ grip will be mounted to a straight section of the first rod as formed into the pull, then the notch in the cut section of the second rod will be concave and cylindrical with an inner radius of X); and (c) attaching the DQ grip component (the cut-off section of the second rod) to the pull (the formed first rod) by fitting the notched end of the cut-off section of the second rod over the first section of the pull; and securing the DQ grip component to the pull by a means such as welding the cut section of the second rod to the pull, using a fastener or gluing.

The second rod may need to be cut a little longer so that the DQ grip element is an appropriate length after accounting for the notch. The DQ grip component can be made in other ways than from a rod, such as by machining a bulk material or casting. The DQ grip can be attached to the pull by means other than welding, such as by use of a fastener (in this case, there would be a steps of drilling a hole through the center of one support of the pull or the handle, drilling a longitudinal hole into the bottom of the DQ grip within the notch and then forming threads in the hole in the bottom of the DQ grip, and then inserting a bolt through the hole in the pull's support or handle and screwing it into the hole in the DQ grip until it is tight). A DQ grip component can be designed for attachment to a pull at the elbow; the geometry of the notch will be more complicated, but should still allow the DQ grip to fit snugly against the pull. The DQ grip component can be made of a material other than metal and if so a means of attachment to the pull other than welding will be appropriate. The pull and the DQ grip can be made out of materials other than metals, such as polymers or polymeric composites, in which case the step of welding the DQ grip to the pull may be replaced by a step of chemically welding or gluing the DQ grip to the pull.

The general method for making a door opener of the present invention when starting with a prior art door opener is as follows: provide a door opener; select an area at which to attach a DQ grip component to the door opener conforming to the design principles described herein; make a DQ grip component according to the DQ grip design principles described herein; form a first end of the DQ grip component so that it conforms to the shape of the area at which the DQ grip component will be attached to the door opener; and securely affix the DQ grip component to the door opener at the selected area with the formed first end of the DQ grip component against the area of the door opener to which it conforms, such as by welding, gluing or a fastener. For example, if the door opener and DQ grip are made from metal, and the DQ grip is cylindrical, the method can more specifically be: provide a provide a door opener; select an area at which to attach a DQ grip to the door opener such that when the door opener with a attached the DQ grip is attached to a door, the DQ grip will be at least 1 inch from the door, and preferably 1.5 or 2 or more inches, the longitudinal axis of the DQ grip will be roughly perpendicular to the force to open the door, and the DQ grip will extend from the door opener at an appropriate angle (generally between horizontal and vertically upwards); make a DQ grip component that when attached to the door opener extend out from the door opener between about 0.25 and 0.75 inches (or any of the ranges of heights given elsewhere herein) and which has a diameter of between about 0.25 and 0.625 inches (or any of the ranges for cross-sectional dimensions given elsewhere herein); form a first end of the DQ grip component so that it conforms to the shape of the area at which the DQ grip component will be attached to the door opener; and weld the DQ grip component to the door opener at the selected area with the formed first end of the DQ grip component against the area of the door opener to which it conforms.

In a variation of the above method, the door opener (such as the pull) is adapted to fit the DQ grip component. For example, if the DQ grip is cylindrical and the door opener is a pull formed from a cylindrical rod (one with a circular cross section), a cylindrical hole can be drilled into (or formed in) the pull that has a slightly larger diameter than the DQ grip component has at a first end, and the first end of the DQ grip component can fitted into the cylindrical hole in the pull and then securely affixed therein, such as by welding, pinning, an adhesive or a fastener. The first end of the DQ grip component can be made to both conform to the door opener at the point of attachment but also penetrate into the door opener. Alternately, one end of the DQ grip piece can have threads formed in it and the hole in the door opener can have matching threads, and the DQ grip is attached to the door opener by screwing it into the hole in the door opener.

FIG. 15 shows a cylindrical DQ grip 1403 that is incorporated into a pivoting lever 1400 with its longitudinal axis 1404 roughly parallel to the lever's axis of rotation 1405. The lever 1400 comprises an elongate handle 1402 attached at a first end 1406 to a base 1401 at a roughly right angle and at its second, free end 1407 to a cylindrical DQ grip 1403 which projects outwards at a roughly right angle from the handle 1402. The lever 1400 will be attached to an element that can be rotated around an axis to cause some action, such as the valve stem of a faucet or a door latching mechanism which respectively when rotated using the lever 1402 will turn on or off the flow of a liquid or unlatch or latch a door (some bathroom stall door latches are of this type). The DQ grip will extend away from the surface to which the rotatable element is attached. In one embodiment, the lever 1400 is a faucet handle and the base 1401 is attached to the faucet's valve stem. A DQ grip symmetrical around its longitudinal axis 1404 (such as a cylindrical or conical one) is preferred since it will be able to rotate while being grasped with less resistance than an asymmetrical DQ grip. When a DQ grip is incorporated into a lever as described in this paragraph, it is used to apply a force tangential to the arc of rotation of the lever. In one embodiment, the DQ grip 1403 is replaced by a DQ grip assembly such as DQ grip assembly 165 that is part of the door opener 160 shown in FIG. 1C. In a further embodiment, the DQ grip assembly is attached to the second end 1407 of the handle 1402 such that the DQ grip is axially aligned with the handle; this embodiment is appropriate for the handle on a side-mounted drinking fountain faucet, and the flange of the DQ grip assembly will limit skin contact to the pinky of the user and prevent the user's hand from slipping down the lever.

A novel method for opening a door to which a door opener is attached is also disclosed. This method comprises: providing a door opener comprising a DQ grip; grasping the DQ grip with a pinky; and applying a force to the DQ grip in a direction that will cause the door to open or close. The door opener can be any of the door openers described herein. In one embodiment, the method for opening a door comprises the further step of attaching the door opener to a door. In one embodiment, the force to open the door is applied to the DQ grip roughly orthogonal to the surface of the door. In one embodiment, the force to open the door is applied to the DQ grip roughly parallel to the surface of the door. In one embodiment, the force to open the door is applied in the direction of movement of the door. In one embodiment, the DQ grip is grasped by wrapping the pinky around its lateral sides. In one embodiment, the DQ grip is between about 0.375 and 0.625 inches long and has an average maximum cross-sectional of between about 0.25 and 0.5 inches. In one embodiment, the DQ grip projects from a surface of the door opener such that when the door opener is mounted to the door, the longitudinal axis of the DQ grip is oriented between horizontal and vertically up.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of” are closed or semi-closed transitional phrases, respectively, with respect to the claims.

The inventions herein are not limited in their application to the details of construction and the arrangement of components set forth in the preceding description or illustrated in the drawings. The inventions are capable of embodiments and of being practiced or of being carried out in various ways beyond those exemplarily presented herein.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Further, acts, elements, and features discussed only in connection with one embodiment are not intended to be excluded from a similar role in other embodiments.

It is to be appreciated that various alterations, modifications, and improvements can readily occur to those skilled in the art and that such alterations, modifications, and improvements are intended to be part of the disclosure and within the spirit and scope of the invention.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used.

Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

What is claimed:

1. A door opener comprising a first handle having sufficient length or girth for a substantial portion of at least two fingers to be in contact with it; and a second handle that only one finger at a time can be substantially in contact with.

2. The door opener of claim 1 wherein the second handle has a longitudinal dimension of between about ⅜ inch and ¾ inch.

3. The door opener of claim 1 wherein the second handle has a maximum cross-sectional transverse dimension at its longitudinal midpoint of between about ¼ inch and ¾ inch.

4. The door opener of claim 1 wherein the longitudinal axis of the second handle is roughly perpendicular to the direction of movement of the door when opening and closing.

5. The door opener of claim 4 wherein the longitudinal axis of the second handle is at an angle of between 45 degrees below horizontal to 90 degrees above the horizontal.

6. The door opener of claim 1 wherein the first handle comprises a pull.

7. The door opener of claim 1 wherein the first handle comprises a knob.

8. The door opener of claim 1 wherein the first handle comprises a lever.

9. The door opener of claim 1 wherein the first handle comprises a push bar.

10. The door opener of claim 1 wherein the first handle comprises push-pull paddle.

11. The door opener of claim 1 wherein the first handle comprises pull plate.

12. The door opener of claim 6 wherein the first handle and the second handle each have longitudinal axes and longitudinal axis of the first handle is not aligned not aligned with the longitudinal axis of the second handle.

13. The door opener of claim 12 wherein the longitudinal axis of the second handle is not parallel to the longitudinal axis of the first handle.

14. A door handle comprising a support adapted for mounting to a door, and a first grip attached to the support and having a longitudinal axis roughly orthogonal to the direction of movement of the door to which it is mounted, a length of between about one-quarter inch and three-quarter inch, and a maximum transverse cross-sectional dimension of about three-quarter inch measured at least one-quarter inch away from the support.

15. The door handle of claim 14 wherein the support comprises a door opener.

16. The door handle of claim 15 wherein the door opener comprises a second grip.

17. The door handle of claim 16 wherein the second grip has sufficient length or girth for a substantial portion of at least two fingers to be in contact with it when in use.

18. A method of making sanitary door opener comprising the steps of: providing a manual door opener having a first handle large enough to be grasped by wrapping two or more fingers around it; attaching a first end of a second handle to the door opener such that a longitudinal axis of the second handle will be at an angle of between forty-five degrees below horizontal to ninety degrees above horizontal in a plane roughly perpendicular to the direction of the force to open the door and a second end of the second handle is a distance of between about 0.25 and 0.75 inch from the door opener; wherein the maximum cross-sectional dimension of the second handle measured about 0.25 inch from the door opener is between about 0.25 and 0.75 inch.

19. The method of making a sanitary door opener of claim 18 wherein the first end of the second handle comprises a clamp.

20. The method of making a sanitary door opener of claim 18 wherein the manual door opener is a pull.

21. The method of making a sanitary door opener of claim 18 wherein the first end of the second handle is shaped to conform to a portion of the manual door opener.
